(19) United States
(12) Patent Application Publication
(10) Pub. No.: US 2011/0134029 A1
(43) Pub. Date: Jun. 9, 2011

(54) ELECTRONIC DEVICE AND A POINTER MOTION CONTROL METHOD THEREOF

(75) Inventors: Yeung Jun Park, Gyeonggi-Do (KR); In-Soo Bae, Gyeonggi-Do (KR); Dae Kyum Kim, Incheon (KR)

(73) Assignee: INNOCHIPS TECHNOLOGY CO., LTD., Ansan-Si, Gyeonggi-Do (KR)

(21) Appl. No.: 12/933,663

(22) PCT Filed: Mar. 19, 2009
(86) PCT No.: PCT/KR2009/001397

§ 371 Date: Oct. 19, 2010

(30) Foreign Application Priority Data
Mar. 20, 2008 (KR) 10-2008-0025956
Apr. 14, 2008 (KR) 10-2008-0034180

(51) Int. Cl. G09G 5/08

(52) U.S. Cl. 345/157

(57) ABSTRACT

Provided are an electronic device and a method for controlling movement of a pointer of the electronic device. Movement of a pointer (or a cursor or an activated icon region) displayed on a display unit can be smoothly controlled using a sensing signal output according to two-dimensional movement of an intermediate member (that is, a magnet part or a senor part) for providing improved manipulation sensitivity to users.

### BACKGROUND

The present disclosure relates to an electronic device and a method for controlling movement of a pointer of the electronic device, and more particularly, to a method for controlling movement of a pointer (or a cursor) displayed on a display unit of an electronic device including a pointing control unit.

Recent electronic devices are small and easy to use owing to graphic user interface (GUI). Various pointer movement control devices (or pointing control units) such as mouse devices and touch pads are used to control movement of a pointer of GUI.

In the related art, the direction and displacement of a pointer on a screen are determined by the direction and displacement of a mouse or the direction and displacement of an object touching a touch pad. In some devices, a desired ion is activated by moving an activated icon region on a screen according to the movement of an object touching on a touch pad. In those cases, the mouse or the object touching on a touch pad should be moved on a wide area to move a pointer smoothly on a screen. Therefore, mouse devices and touch pads of the related art are not suitable for small electronic devices because they are large or require a relatively large area for manipulation.

In another method, up, down, left, and right movement buttons (+x-axis, −x-axis, +y-axis, and −y-axis buttons) are disposed around a central click button so that a pointer (that is, an activated icon region) can be moved up, down, left, and right by clicking the buttons. However, since the movement buttons are usually formed using dome switches, a relatively large space is required to install the dome switches, and thus it is difficult to reduce the size of a device. Furthermore, since a plurality of movement buttons as well as the central click button is required, manufacturing costs increase.

In a recently pointer movement control device, a sensor capable of detecting the movement direction and magnetic intensity of a magnet is disposed to control movement of a pointer on a screen according to two-dimensional movement of the magnet. Since a signal for controlling movement of the pointer is generated by detecting variations of a magnet field caused by the magnet, the pointer movement control device can be small and light. However, due to a narrow sensor movement space of such a pointer movement control device configured to generate a pointer movement control signal according to movement of a magnet (or a sensor), the movement of a pointer on a screen (a display region of an electronic device) can be largely changed, and thus it is difficult to control the movement of the pointer. Furthermore, if the magnet is moved between axes, an axial movement of the magnet may not be properly detected. In this case, an activated icon region may not be properly moved in a desired direction, and thus a desired icon may not be easily activated.

### SUMMARY

The present disclosure provides an electronic device configured to smoothly control movement of a pointer (that is, an activated icon region) on a screen by using sensor movement signals output according to movement of a sensor of a pointing movement control device, and a method for controlling movement of the pointer of the electronic device.

In accordance with an exemplary embodiment, there is provided a method for controlling movement of a pointer on a screen of an electronic device by using pointer movement control signals generated using sensing signals, which have various levels and output according to user's manipulation of a sensor, the method including: defining a plurality of sections corresponding the sensing signals and defining the sensing signals as 0th to Mth sensing signals according to the sections; generating and storing a reference lookup table and a plurality of variable lookup tables, the reference lookup table including weight values corresponding to the 0th to Mth sensing signals and levels of the pointer movement control signals, each of the variable lookup tables including weight values corresponding to the 0th to Mth sensing signals and different from the weight values of the reference lookup table; determining whether a current sensing signal has a maximal level; if the current sensing signal has the maximal level, performing an acceleration mode so as to accelerate the movement of the pointer on the screen, and if the current sensing signal does not have the maximal level, determining whether a previous sensing signal has a minimal level; if the previous sensing signal does not have the minimal level, performing a continuous movement mode, and if the previous sensing signal has the minimal level, comparing sections of the previous and current sensing signals; if a difference between the sections of the previous and current sensing signals is greater than L, generating a pointer movement control signal having a weight value corresponding to the current sensing signal by using one of the variable lookup tables, and if the difference of the sections is smaller than the L, generating a pointer movement control signal having a weight value corresponding to the current sensing signal by using another of the variable lookup tables.

The L may be a natural number selected from 2, 3, and 4.

The performing of the acceleration mode may include: determining whether a maximal-level continuation number K is greater than value N; if the K is smaller than the N, generating a pointer movement control signal having a weight value corresponding to the current sensing signal by using the reference lookup table, adding 1 to the K, determining whether the increased K is greater than the N if a next new sensing signal has the maximal level, and terminating the acceleration mode if the new sensing signal does not have the maximal level; and if the K is equal to or greater than the N, generating a pointer movement control signal having a weight value that is obtained by increasing a weight value of the reference lookup table corresponding to the maximal level by a value corresponding to the K, adding 1 to the K, and generating a pointer movement control signal having a new weight value obtained by increasing the weight value of the reference lookup table corresponding to the maximal level by a value corresponding to the increased K if a next new sensing signal has the maximal level.

The N may be a natural number selected from 2 to 15.

The performing of the continuous movement mode may include: determining whether levels of the sensing signals are increased or decreased; if the levels of the sensing signals are increased, generating a pointer movement control signal having a weight value corresponding to the current sensing signal by using another of the variable lookup tables; and if the levels of the sensing signals are decreased, comparing the sections of the previous and current sensing signals so as to generates a pointer movement control signal having a zero level if the difference between the sections of the previous and current sensing signals is greater than P and generate a pointer movement control signal having a weight value corresponding to the current sensing signal by using the variable lookup table or another of the variable lookup tables if the difference between the sections of the previous and current sensing signals is smaller than the P.

The P may be a natural number selected from 2, 3, and 4.

The sensor may be a magnet part, and the levels of the sensing signals may be varied according to movement of the magnet part, wherein a length of an axis defined from an original position of the magnet part to a most distant position of the magnet part from the original position may be divided into first to seventh sensor signal sections to classify the levels of the sensing signals into first to seventh levels according to the first to seventh sensor signal sections.

The reference lookup table and the variable lookup tables may include: first weight values corresponding to sections of an x-axis or a y-axis defined in a +x-axis or +y-axis direction from the original position of the magnet part to a most distant position of the magnet part; and second weight values corresponding to sections of the x-axis or the y-axis defined in a −x-axis or −y-axis direction from the original position of the magnet part to a most distant position of the magnet part, wherein the first weight values are positive or negative in sign, the second weight values have the opposite sign, and the first weight values and the second weight values are equal in absolute value.

The weight values of the reference lookup table may increase sequentially in accordance with the first to seventh levels of the sensing signals; the weight values of one of the variable lookup tables may include 0 corresponding to the first level, 1 corresponding to the second to fourth levels, and 3 corresponding to the fifth to seventh levels; the weight values of another of the variable lookup tables may include 0 corresponding to the first and second levels, 1 corresponding to the third and fourth levels, and 3, 4, and 7 corresponding to the fifth, sixth, and seventh levels, respectively; and the weight values of another of the variable lookup tables may include 0 corresponding to the first level, 1 corresponding to the second to fourth levels, and 3, 4, and 5 corresponding to the fifth, sixth, and seventh levels, respectively.

In accordance with another exemplary embodiment, an electronic device includes: a pointing control unit configured to output sensing signals having various levels by detecting movement of a magnet part disposed within a hole-shaped movement space; and a pointer control module configured to define a plurality of sections corresponding the sensing signals and defining the sensing signals as 0th to Mth sensing signals according to the sections, the pointer control module being configured to generate a pointer movement control signal having a weight value corresponding to a current sensing signal by using the 0th to Mth sensing signals, a reference lookup table and a plurality of variable lookup tables including various weight values corresponding to levels of pointer movement control signals for controlling movement of a pointer on a screen, and the current sensing signal and a previous sensing signal.

The pointer control module may be configured to perform the operations of: if the current sensing signal has a maximal level, performing an acceleration mode so as to accelerate the movement of the pointer on the screen, and if the current sensing signal does not have the maximal level, determining whether the previous sensing signal has a minimal level to perform a continuous movement mode if the previous sensing signal does not have the minimal level, if the previous sensing signal has the minimal level, comparing sections of the previous and current sensing signals so as to generate a pointer movement control signal having a weight value corresponding to the current sensing signal by using one of the variable lookup tables if a difference between the sections of the previous and current sensing signals is greater than L, and generate a pointer movement control signal having a weight value corresponding to the current sensing signal by using another of the variable lookup tables if the difference of the sections is smaller than the L.

In accordance with another exemplary embodiment, there is provided a pointing device configured to control movement of a pointer on a screen by using pointer movement control signals generated using sensing signals having various levels and output according to user's manipulation of a sensor, the pointing device being configured to define a plurality of sections corresponding the sensing signals and classify the sensing signals into 0th to Mth sensing signals according to the sections, and generate and store a reference lookup table and a plurality of variable lookup tables, the reference lookup table including weight values corresponding to the 0th to Mth sensing signals and levels of the pointer movement control signals, each of the variable lookup tables including weight values corresponding to the 0th to Mth sensing signals and different from the weight values of the reference lookup table, the pointing device including a program code configured to control the movement of the pointer on the screen by executing the operations of: determining whether a current sensing signal has a maximal level; if the current sensing signal has the maximal level, performing an acceleration mode so as to accelerate the movement of the pointer on the screen, and if the current sensing signal does not have the maximal level, determining whether a previous sensing signal has the minimal level; if the previous sensing signal does not have the minimal level, performing a continuous movement mode, and if the previous sensing signal has the minimal level, comparing sections of the previous and current sensing signals; if a difference between the sections of the previous and current sensing signals is greater than L, generating a pointer movement control signal having a weight value corresponding to the current sensing signal by using one of the variable lookup tables, and if the difference of the sections is smaller than the L, generating a pointer movement control signal having a weight value corresponding to the current sensing signal by using another of the variable lookup tables.

The performing of the acceleration mode may include: determining whether a maximal-level continuation number K is greater than value N; if the K is smaller than the N, generating a pointer movement control signal having a weight value corresponding to the current sensing signal by using the reference lookup table, adding 1 to the K, determining whether the increased K is greater than the N if a next new sensing signal has the maximal level, and terminating the acceleration mode if the new sensing signal does not have the maximal level; and if the K is equal to or greater than the N, generating a pointer movement control signal having a weight value that is obtained by increasing a weight value of the reference lookup table corresponding to the maximal level by a value corresponding to the K, adding 1 to the K, and generating a pointer movement control signal having a new weight value obtained by increasing the weight value of the reference lookup table corresponding to the maximal level by a value corresponding to the increased K if a next new sensing signal has the maximal level.

The performing of the continuous movement mode may include: determining whether levels of the sensing signals are increased or decreased; if the levels of the sensing signals are increased, generating a pointer movement control signal having a weight value corresponding to the current sensing signal by using another of the variable lookup tables; and if the levels of the sensing signals are decreased, comparing the sections of the previous and current sensing signals so as to generates a pointer movement control signal having a zero level if the difference between the sections of the previous and current sensing signals is greater than P and generate a pointer movement control signal having a weight value corresponding to the current sensing signal by using the variable lookup table or another of the variable lookup tables if the difference between the sections of the previous and current sensing signals is smaller than the P.

In accordance with another exemplary embodiment, there is provided a method for controlling movement of a pointer of an electronic device to activate an icon of the electronic device by moving an activated icon region on a screen according to movement of an intermediate member confined in a movement range of a two-dimensional plane, the method including: dividing the movement range of the intermediate member into a plurality of division regions to which movement directions of the activated icon region are allocated, and storing a plurality of reference movement ranges by varying sizes of the division regions of the movement range so that the division regions of each of the reference movement ranges have different sizes from the division regions of the other reference movement ranges; and selecting one of the reference movement ranges according to a position of the intermediate member so as to move the activated icon region on the screen by using the selected reference movement range.

The selecting of one of the reference movement ranges may be performed by selecting one of the reference movement ranges having a largest division region where the position of the intermediate member is located.

The intermediate member may be two-dimensionally moved with respect to a center point of the movement range, and the movement range may be divided into division regions based on the center point, and when the intermediate member is placed at the center point of the movement range, one of the reference movement ranges of which division regions have the same size may be selected.

The division regions may include an upper division region at an upper side of the center point, a lower division region at a lower side of the center point, a left division region at a left side of the center point, and a right division region at a right side of the center point, and when the intermediate member is placed on a boundary of the division regions, it may be determined that the intermediate member is placed on the left or right division region.

If the intermediate member is placed at the center point, the upper, lower, left, and right division regions may become 90-degree angular regions defined with respect to the center point, and if the intermediate member is moved from the center point to one of the upper, lower, left, and right division regions, the corresponding division region may be enlarged to an approximately 100-degree to 140-degree angular region with respect to the center point, and two of the remaining division regions neighboring the enlarged division region may be reduced in size by the enlarged size of the enlarged division region.

In accordance with another exemplary embodiment, there is provided a method for controlling movement of a pointer of an electronic device to activate an icon of the electronic device by moving an activated icon region on a screen according to movement of an intermediate member confined in a movement range of a two-dimensional plane defined by an x-axis and a y-axis, the method including: dividing the movement range of the intermediate member into ±x-axis movement regions adapted to move the activated icon region in an x-axis direction, and ±y-axis movement regions adapted to move the activated icon region in a y-axis direction; and enlarging one pair of the ±x movement regions and the ±y-axis movement regions where the intermediate member is placed as compared with the other pair where the intermediate member is not placed.

If the intermediate member is placed at a center point of the movement range, the ±x-axis movement regions and the ±y-axis movement regions may have the same size, and if the intermediate member is placed on a boundary between the ±x movement regions and the ±y-axis movement regions, the ±x-axis movement regions may be enlarged relative to the ±y-axis movement regions.

The method may further include: storing a first movement range by dividing the movement range of the intermediate member into ±x-axis movement regions and ±y-axis movement regions having the same size, a second movement range by diving the movement range of the intermediate member into ±x-axis movement regions and ±y-axis movement regions smaller than the ±x-axis movement regions, a third movement range by diving the movement range of the intermediate member into ±x-axis movement regions and ±y-axis movement regions larger than the ±x-axis movement regions; if the intermediate member is placed at the center point of the movement range, determining a movement direction of the activated icon region by using the first movement range; if the intermediate member is placed in the +x-axis or −x-axis movement region, determining a movement direction of the activated icon region by using the second movement range; and if the intermediate member is placed in the +y-axis or −y-axis movement region, determining a movement direction of the activated icon region by using the third movement range.

The method may further include: storing a first movement range by dividing the movement range of the intermediate member into ±x-axis movement regions and ±y-axis movement regions having the same size, a second movement range by diving the movement range of the intermediate member into ±x-axis movement regions and ±y-axis movement regions smaller than the ±x-axis movement regions, a third movement range by diving the movement range of the intermediate member into ±x-axis movement regions and ±y-axis movement regions larger than the ±x-axis movement regions; if a previous position of the intermediate member is the center point of the movement range, determining a movement direction of the activated icon region according to a current position of the intermediate member by using the first movement range; if the current position of the intermediate member is in the +x-axis or −x-axis movement region, using the second movement range instead of the first movement range; and if the current position of the intermediate member is in the +y-axis or −y-axis movement region, using the third movement range instead of the first movement range.

If the previous position of the intermediate member is not the center point of the movement range and the movement range is changed to the second movement range by the previous position of the intermediate member, a movement direction of the activated icon region according to the current position of the intermediate member may be determined by the second movement range; and if the current position of the intermediate member is in the +y-axis or −y-axis movement region, the third movement range may be used.

If the previous position of the intermediate member is not the center point of the movement range and the movement range is changed to the third movement range by the previous position of the intermediate member, a movement direction of the activated icon region according to the current position of the intermediate member may be determined by the third movement range; and if the current position of the intermediate member is in the +x-axis or −x-axis movement region, the second movement range may be used.

The ±x-axis movement regions of the first movement range may be angular regions equal to or greater than −45 degrees but equal to or smaller than +45 degrees with respect to the x-axis, and the ±y-axis movement regions of the first movement range may be angular regions greater than −45 degrees but smaller than +45 degrees with respect to the y-axis.

If the +x-axis is 0 degrees, the +x-axis movement region of the first movement range may be defined by an angular region equal to or greater than 315 degrees but equal to or smaller than 45 degrees, the +y-axis movement region of the first movement range may be defined by an angular region greater than 45 degrees but smaller than 135 degrees; the −x-axis movement region of the first movement range may be defined by an angular region equal to or greater than 135 degrees but equal to or smaller than 225 degrees; and the −y-axis movement region of the first movement range may be defined by an angular region greater than 225 degrees but smaller than 315 degrees.

The ±x-axis movement regions of the second movement range may be angular regions equal to or greater than −60 degrees but equal to or smaller than +60 degrees with respect to the x-axis, and the ±y-axis movement regions of the second movement range may be angular regions greater than −30 degrees but smaller than +30 degrees with respect to the y-axis.

If the +x-axis is 0 degrees, the +x-axis movement region of the second movement range may be defined by an angular region equal to or greater than 300 degrees but equal to or smaller than 60 degrees; the +y-axis movement region of the second movement range may be defined by an angular region greater than 60 degrees but smaller than 120 degrees; the −x-axis movement region second may be defined by an angular region equal to or greater than 120 degrees but equal to or smaller than 240 degrees; and the −y-axis movement region second may be defined by an angular region greater than 240 degrees but smaller than 300 degrees.

The ±x-axis movement regions of the third movement range may be angular regions equal to or greater than −30 degrees but equal to or smaller than +30 degrees with respect to the x-axis, and the ±y-axis movement regions of the third movement range may be angular regions greater than −60 degrees but smaller than +60 degrees with respect to the y-axis.

If the +x-axis is 0 degrees, the +x-axis movement region of the third movement range may be defined by an angular region equal to or greater than 330 degrees but equal to or smaller than 30 degrees; the +y-axis movement region of the third movement range may be defined by an angular region greater than 30 degrees but smaller than 150 degrees; the −x-axis movement region of the third movement range may be defined by an angular region equal to or greater than 150 degrees but equal to or smaller than 210 degrees; and the −y-axis movement region of the third movement range may be defined by an angular region greater than 210 degrees but smaller than 330 degrees.

In accordance with another exemplary embodiment, an electronic device includes: a pointing control unit configured to output a plurality of sensing signals by detecting movement of a magnet part confined in a movement range of a two-dimensional plane defined by an x-axis and a y-axis; and a pointer control module configured to move an activated icon region on a screen by determining a coordinate of the magnet part using the sensing signals, dividing the movement range of the magnet part into a plurality of division regions to which movement directions of the activated icon region are allocated, storing a plurality of reference movement ranges by varying sizes of the division regions of the movement range so that the division regions of each of the reference movement ranges have different sizes from the division regions of the other reference movement ranges, and selecting one of the reference movement ranges according to the coordinate of the magnet part to move the activated icon region on the screen by using the selected reference movement range.

The division regions may include an upper division region at an upper side of a center point of the movement range, a lower division region at a lower side of the center point, a left division region at a left side of the center point, and a right division region at a right side of the center point, if the magnet part is placed at the center point, the pointer control unit may select one of the reference movement ranges having the same sized division regions, if the magnet part is not placed at the center point, the pointer control module may select one of the reference movement ranges having a largest division region where the magnet part may be place, and if the magnet part is placed on a boundary between the division regions, the pointer control module may determine that the magnet part may be placed on the lift division region or the right division region.

In accordance with another exemplary embodiment, an electronic device includes: a pointing control unit configured to output a plurality of sensing signals by detecting movement of a magnet part confined in a movement range of a two-dimensional plane defined by an x-axis and a y-axis; and a pointer control module configured to determine a coordinate of the magnet part using the sensing signals, divide the movement range of the magnet part into ±x-axis movement regions adapted to move the activated icon region in an x-axis direction and ±y-axis movement regions adapted to move the activated icon region in a y-axis direction, and enlarge one pair of the ±x movement regions and the ±y-axis movement regions where the intermediate member is placed as compared with the other pair where the intermediate member is not placed.

If the magnet part is placed at a center point of the movement range, the ±x-axis movement regions and the ±y-axis movement regions may have the same size, and if the magnet part is placed on a boundary between the ±x-axis movement regions and the ±y-axis movement regions, the ±x-axis movement regions may be enlarged relative to the ±y-axis movement regions.

In accordance with another exemplary embodiment, there is provided a pointing device for moving an activated icon region on a screen according to movement of an intermediate member confined in a movement range of a two-dimensional plane, the pointing device including a program code for executing the operations of dividing the movement range of the intermediate member into a plurality of division regions to which movement directions of the activated icon region are allocated, and storing a plurality of reference movement ranges by varying sizes of the division regions of the movement range so that the division regions of each of the reference movement ranges have different sizes from the division regions of the other reference movement ranges; and selecting one of the reference movement ranges according to a position of the intermediate member so as to move the activated icon region on the screen by using the selected reference movement range.

In accordance with another exemplary embodiment, there is provided a pointing device for moving an activated icon region on a screen according to movement of an intermediate member confined in a movement range of a two-dimensional plane defined by an x-axis and a y-axis, the pointing device including a program code for executing the operations of: dividing the movement range of the intermediate member into ±x-axis movement regions adapted to move the activated icon region in an x-axis direction, and ±y-axis movement regions adapted to move the activated icon region in a y-axis direction; and enlarging one pair of the ±x movement regions and the ±y-axis movement regions where the intermediate member is placed as compared with the other pair where the intermediate member is not placed.

As described above, according to exemplary embodiments, a pointer can be smoothly and easily moved on a screen by varying a weight value according to the state of user's manipulation and adding the weight value to a pointer movement control signal corresponding to a sensor signal generated according to the user's manipulation.

Furthermore, according to exemplary embodiments, an activated icon region can be smoothly moved on the display unit according to movement of the intermediate member (that is, the magnet part or the senor part) confined within a movement range of a two-dimensional plane.

In addition, the movement range of the intermediate member is divided into a plurality of axial movement regions having variable sizes according to movement of the intermediate member, and the axial movement regions are selectively used according to the previous and current states of the intermediate member, so that a user can move an activated icon region on a screen with move sensitivity.

Moreover, according to exemplary embodiments, movement of an activated icon region on a boundary (reference line) between the axial movement regions is determined as movement in the x-axis or y-axis direction, so that the whole movement range of the intermediate member can be used.

### BRIEF DESCRIPTION OF THE DRAWINGS

Exemplary embodiments can be understood in more detail from the following description taken in conjunction with the accompanying drawings, in which:

FIG. 1 is a block diagram illustrating an electronic device in accordance with an exemplary embodiment;

FIG. 2 is a front view illustrating the electronic device in accordance with an exemplary embodiment;

FIG. 3 is a sectional view illustrating a pointing control unit in accordance with an exemplary embodiment;

FIG. 4 is a schematic plan view taken in the direction of arrow A-A of FIG. 3;

FIG. 5 is a schematic view for explaining sensor output sections in accordance with an exemplary embodiment;

FIGS. 6 through 9 illustrate lookup tables for a pointer control module in accordance with an exemplary embodiment;

FIG. 10 is a flowchart for explaining a method of controlling movement of a pointer of an electronic device in accordance with an exemplary embodiment;

FIG. 11 is a flowchart for explaining an acceleration mode in accordance with an exemplary embodiment;

FIG. 12 is a flowchart for explaining a continuous movement mode in accordance with an exemplary embodiment;

FIG. 13 is a front view illustrating an electronic device in accordance with another exemplary embodiment;

FIGS. 14 through 16 are schematic views for explaining operations of the electronic device of FIG. 13; and

FIG. 17 is a flowchart for explaining a method of activating an icon of an electronic device in accordance with an exemplary embodiment.

### DETAILED DESCRIPTION OF THE EMBODIMENTS

Hereinafter, specific embodiments will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. In the figures, like reference numerals refer to like elements throughout.

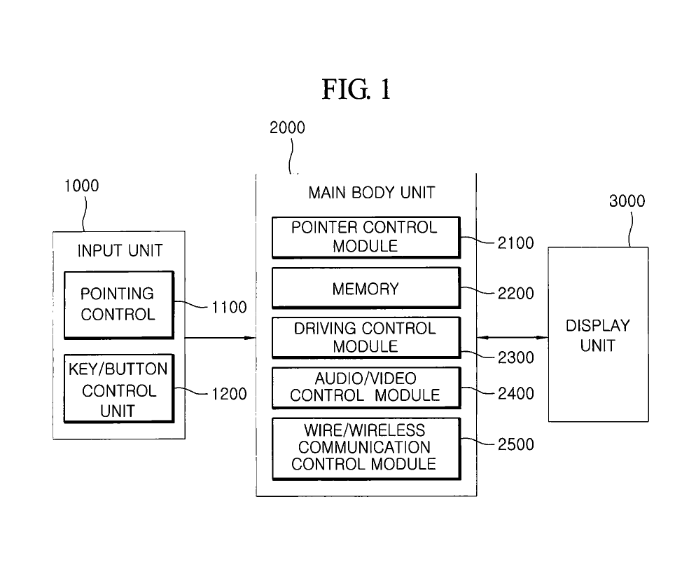

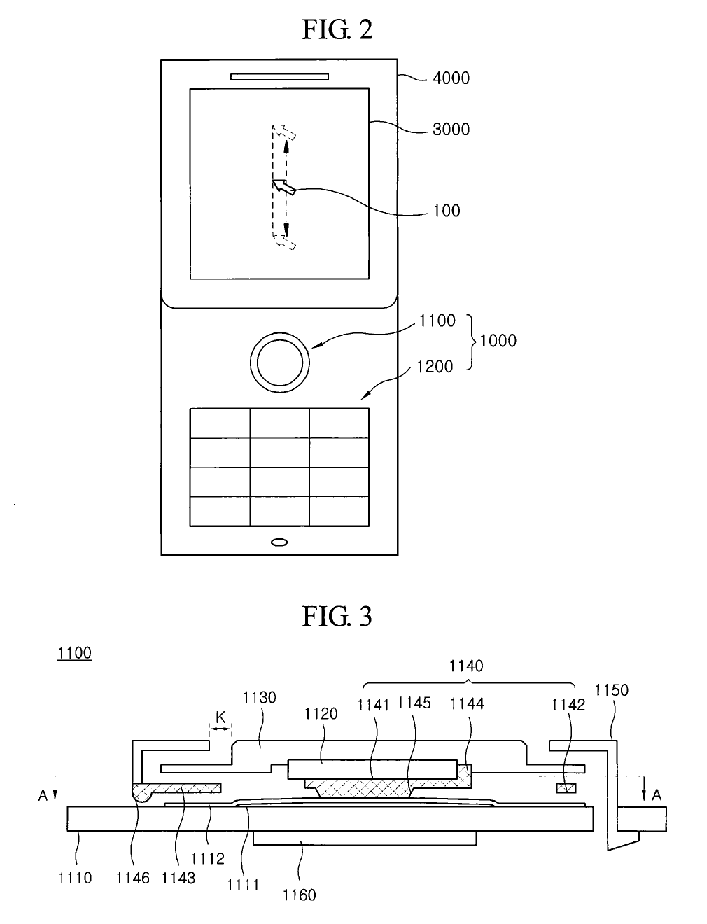

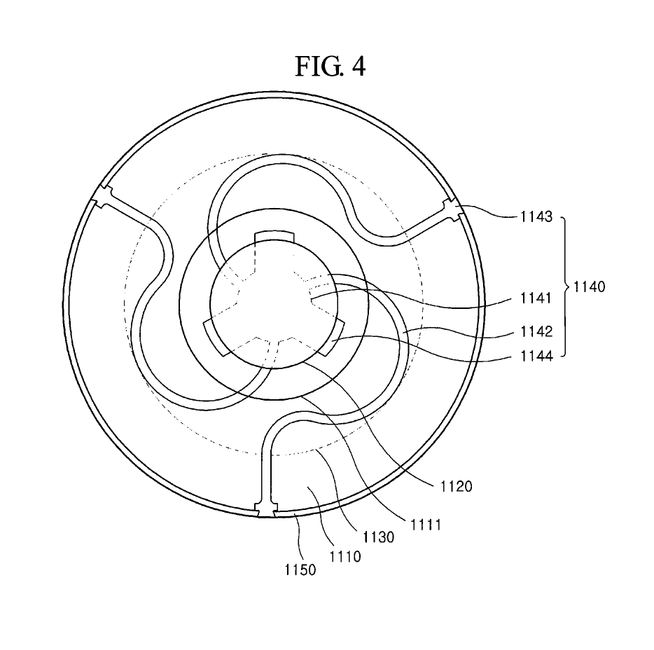

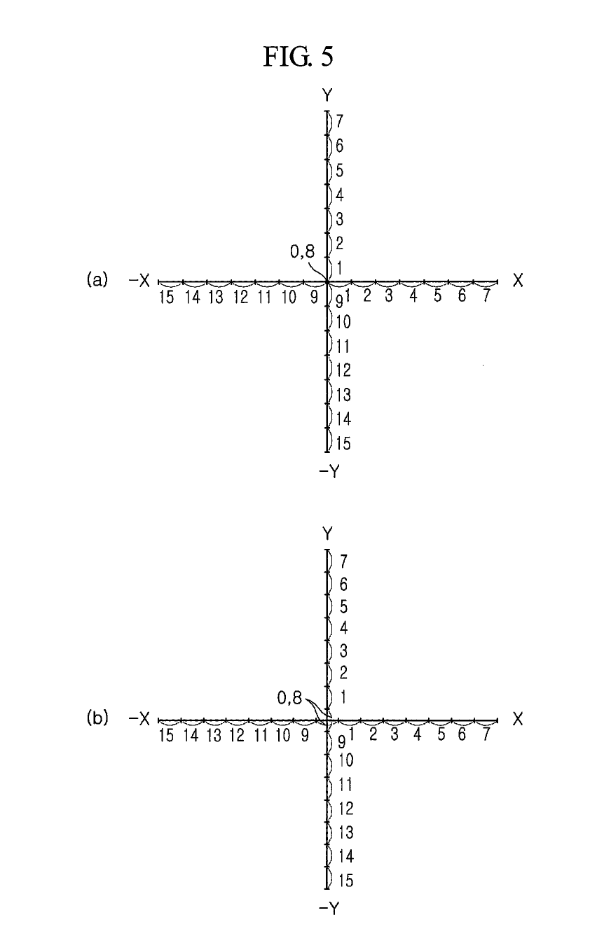

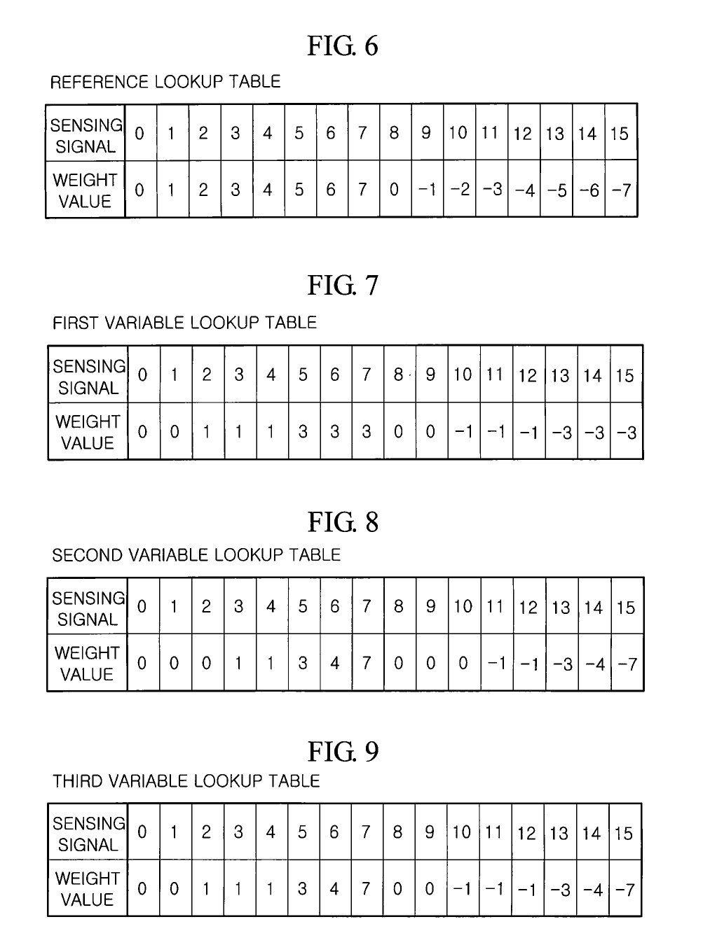

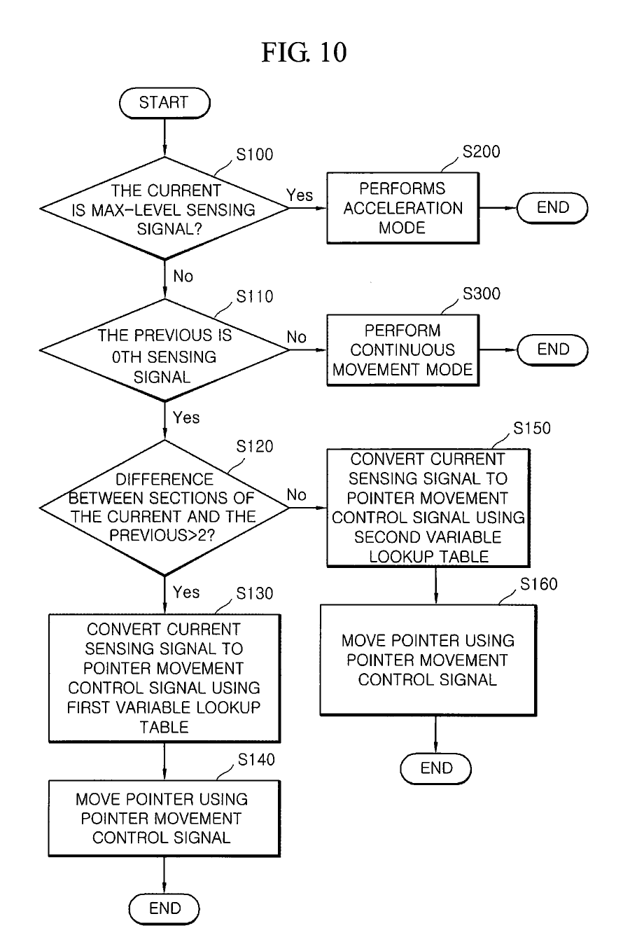

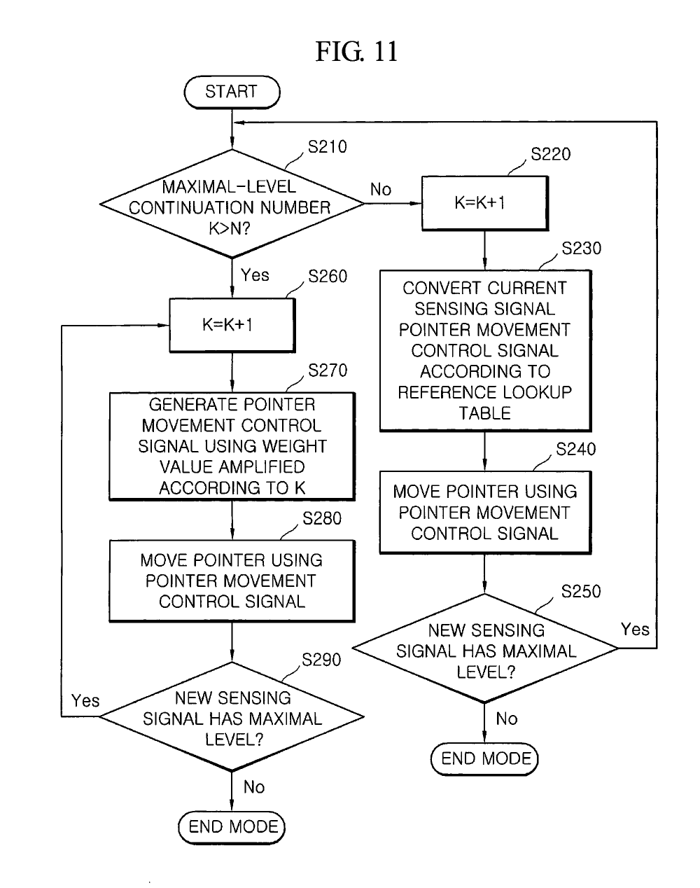

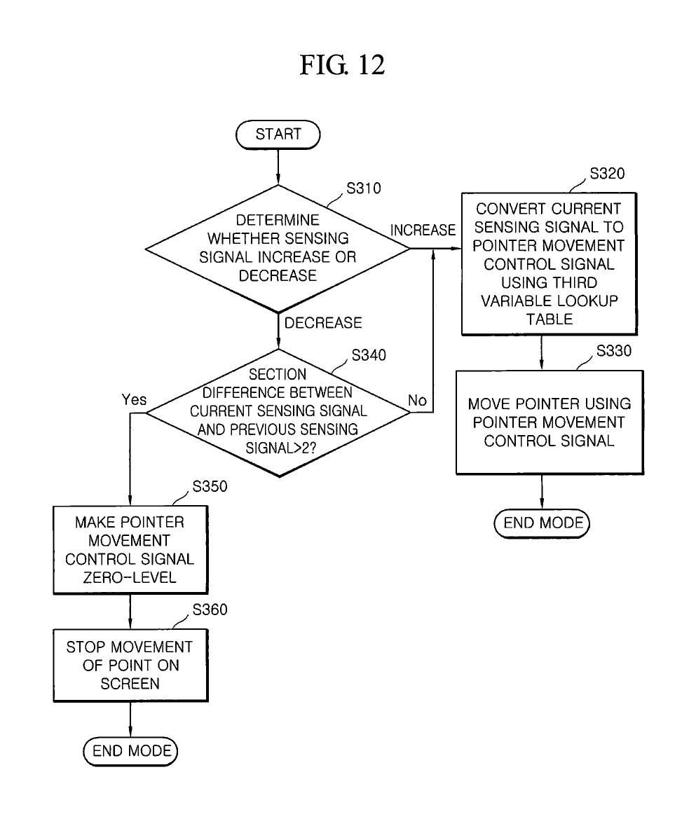

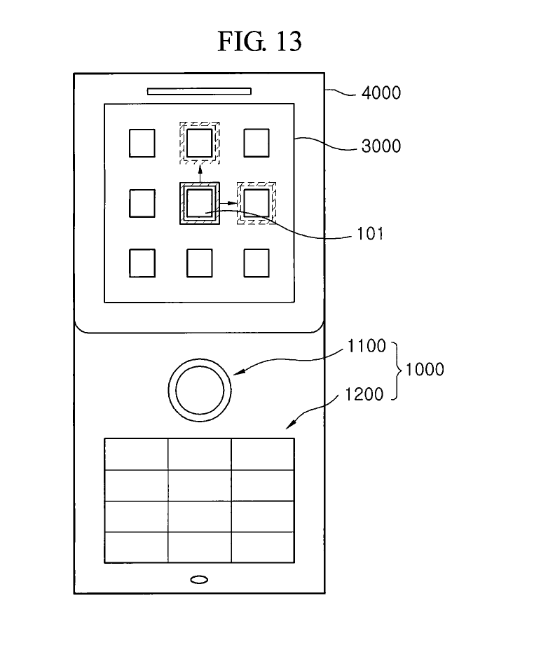

FIG. 1 is a block diagram illustrating an electronic device in accordance with an exemplary embodiment. FIG. 2 is a front view illustrating the electronic device in accordance with an exemplary embodiment. FIG. 3 is a sectional view illustrating a pointing control unit in accordance with an exemplary embodiment, and FIG. 4 is a schematic plan view taken in the direction of arrow A-A of FIG. 3. FIG. 5 is a schematic view for explaining sensor output sections in accordance with an exemplary embodiment. FIGS. 6 through 9 illustrate lookup tables for a pointer control module in accordance with an exemplary embodiment. FIG. 10 is a flowchart for explaining a method of controlling movement of a pointer of an electronic device in accordance with an exemplary embodiment; FIG. 11 is a flowchart for explaining an acceleration mode in accordance with an exemplary embodiment; and FIG. 12 is a flowchart for explaining a continuous movement mode in accordance with an exemplary embodiment.

Referring to FIGS. 1 through 9, the electronic device of the current embodiment includes: a display unit 3000 configured to display a pointer 100 and an image; an input unit 1000 configured to generate a sensing signal according to user's manipulation for moving the pointer 100, and other input signals; and a main body unit 2000 configured to move the pointer 100 according to the sensing signal and transmit a display signal to the display unit 3000 in response to an input signal.

As shown in FIG. 2, the electronic device further includes: a case 40000 configured to accommodate the input unit 1000, the main body unit 2000, and the display unit 3000; and a power supply unit (not shown) configured to supply power to the units.

The display unit 3000 receives an image signal from the main body unit 2000 for displaying an image on a screen and displays a movement of the pointer 100 on the screen according to a pointer movement control signal received from the main body unit 2000. The display unit 3000 may be a liquid crystal display (LCD), a plasma display panel (PDP), a cathode-ray tube (CRT), or organic light emitting diodes (OLEDs).

The input unit 1000 generates an input signal according to a manipulation of a user and transmits the input signal to the main body unit 2000. As shown in FIGS. 1 and 2, the input unit 1000 includes a pointing control unit 1100 and a key/button control unit 1200. The pointing control unit 1100 outputs a sensing signal generated by a sensor according to a manipulation of a user. The key/button control unit 1200 outputs a key or button signal according to a manipulation of a user.

As shown in FIG. 1, the main body unit 2000 includes a pointer control module 2100, a memory 2200, a driving control module 2300, an audio/video control module 2400, and a wire/wireless communication control module 2500. The pointer control module 2100 receives a plurality of sensing signals from the pointing control unit 1100 and generates a pointer movement control signal corresponding to a movement of a sensor, so as to move the pointer 100 of the display unit 3000. The memory 2200 stores various information (data related to video, driving, and controlling). The driving control module 2300 controls overall operations of the main body unit 2000. The audio/video control module 2400 processes audio/video signals received from a separate video input device, video signals (i.e., image signals) to be displayed on the display unit 3000, and audio signals received from a speaker, an earphone, or a microphone. The wire/wireless communication control module 2500 processes data which are received or to be transmitted through a wire/wireless communication method. The main body unit 2000 may further include a modem configured to convert an analog signal to a digital signal, or a digital signal to an analog signal. Although not shown, the main body unit 2000 may be fabricated in the form of a chip in which modules are integrated on a printed circuit board. That is, for example, the main body unit 2000 may be fabricated in the form of a microprocessor or a digital signal processor (DSP). That is, each of the modules of the main body unit 2000 may be fabricated in the form of a chip, or the modules of the main body unit 2000 may be integrated in a single chip.

The electronic device of the current embodiment may provide various functions (such as movie or music display, photographing or video-shooting, wire/wireless communication, web surfing, data processing such as image data processing, and games), and such functions may be executed by using signals and data stored in the main body unit 2000 and signals input through the input unit 1000. However, the present invention is not limited thereto. The electronic device can provide other functions. For example, the electronic device may be a cellular phone. However, the present invention is not limited thereto. For example, the electronic device may be a digital camera, a camcorder, an MP3 player, a PMP, a PDA, a GPS, a laptop computer, an electronic game machine, a remote controller, and an electronic dictionary.

In the current embodiment, when a user manipulates the input unit 1000, the pointing control unit 1100 outputs a sensing signal to the pointer control module 2100, and then the pointer control module 2100 may control the pointer 100 of the display unit 3000 according to the received sensing signal.

Hereinafter, the pointing control unit 1100 installed at the electronic device as shown in FIG. 2 will be explained in more detail with reference to the accompanying drawings in accordance with an exemplary embodiment.

Referring to FIGS. 3 and 4, in accordance with an exemplary embodiment, the pointing control unit 1100 includes a substrate 1110, a magnet part 1120 disposed on the substrate 1110, an actuating member 1130 configured to move the magnet part 1120 according to manipulation of a user, an intermediate member 1140 configured to move, rotate, and restore the magnet part 1120 and the actuating member 1130, a sensor part 1160 configured to output signals according to magnetic field variations caused by movements of the magnet part 1120, and a cover part 1150 fixed to the substrate 1110 in a state where the intermediate member 1140 is fixed to the cover part 1150.

The substrate 1110 may be a printed circuit board. For example, the substrate 1110 may be a printed circuit board (e.g., main substrate) of the main body unit 2000. As shown in FIGS. 3 and 4, a dome switch 1111 is disposed at the top surface of the substrate 1110. Therefore, when the actuating member 1130 is moved downward in a z-axis direction, the dome switch 1111 is pressed by the intermediate member 1140. Upon the dome switch 1111 being pressed, the pointing control unit 1100 outputs a click signal to the main body unit 2000.

As shown in FIG. 3, a lubrication pad 1112 is disposed at least on the dome switch 1111 of the substrate 1110. The lubrication pad 1112 reduces friction between the dome switch 1111 and the intermediate member 1140.

The magnet part 1120 is disposed at center portions of the intermediate member 1140 and the actuating member 1130. The magnet part 1120 is moved according to the movement of the actuating member 1130 and is moved back to its original position by the intermediate member 1140.

The actuating member 1130 is disposed at the top side of the magnet part 1120. The actuating member 1130 is movable by manipulation of a user.

The actuating member 1130 includes a post part and a separation preventing part. The magnet part 1120 is disposed at a center region of the bottom side of the post, and the separation preventing part extends from the post part 410. An upper portion of the magnet part 1120 is inserted and fixed to a lower portion of the post part. The separation preventing part prevents the actuating member 1130 from escaping away from the cover part 1150 disposed at the upper side of the actuating member 1130.

The actuating member 1130 is configured to be moved and rotated by an external force (that is, a manipulation motion of a user), and the movement or rotation of the actuating member 1130 is transmitted to the magnet part 1120. That is, since the magnet part 1120 fixed to the actuating member 1130, the magnet part 1120 is moved and rotated together with the actuating member 1130.

If the external force applied to the actuating member 1130 is removed, the actuating member 1130 and the magnet part 1120 are returned to their original positions by the intermediate member 1140. In the current embodiment, the intermediate member 1140 is configured to fix the magnet part 1120 to the actuating member 1130 and apply an elastic resilient force.

As shown in FIG. 4, the intermediate member 1140 includes a center part 1141, a plurality of pattern parts 1142 extending form the center part 1141, a plurality of fixing parts 1143 disposed at end portions of the pattern parts 1142, and fixing protrusion parts 1144 protruded from the center part 1141 for supporting and positioning the magnet part 1120. As shown in FIG. 4, the center part 1141 includes a click protrusion part 211 protruded downward from the bottom side of the center part 1141. The intermediate member 1140 may be formed of a high-strength plastic (e.g., polyoxymethylene (POM) or Polycarbonate (PC)) by an injection molding method. In this case, since the intermediate member 1140 can be manufactured through a simple process, mass production of the intermediate member 1140 can be easily carried out. In addition, the center part 1141, the pattern parts 1142, the fixing parts 1143, and the fixing protrusion parts 1144 of the intermediate member 1140 may be formed in one piece. However, the present invention is not limited thereto. The intermediate member 1140 may be formed of a metal. In this case, the intermediate member 1140 may be formed through a metal etching or cutting process. The intermediate member 1140 may be formed of a lubricant, abrasion-resistant, and elastically resilient material.

The center part 1141 has a circular plate shape. The center part 1141 is located at the center position of the fixing parts 1143. In the current embodiment, three fixing parts 1143 are disposed around the center of the center part 1141 as shown in FIG. 4. In detail, the center of the center part 1141 is located at the center of a triangle formed by the three fixing parts 1143.

As shown in FIGS. 3 and 4, the center part 1141 may be smaller than the magnet part 1120 placed at the top side of the center part 1141.

In the current embodiment, each of the pattern parts 1142 is formed in a curved strip shape extending between the center part 1141 and the fixing part 1143. In the current embodiment, the intermediate member 1140 may further include a plurality of deflection preventing protrusion parts 1146 on bottom surfaces of the pattern parts 1142.

As shown in FIG. 4, each of the pattern parts 1142 is approximately S-shaped (that is, a sinusoidal curve shape). As shown in FIG. 4, each of the pattern parts includes: a first connection part connected to the center part 1141; a first extension strip part extending from the first connection part in a circular arc shape; a second extension strip part bent and extending from the first extension strip part in a circular arc shape; and a second connection part extending from the second extension strip part and connected to the fixing part 1143. The first and second extension parts are curved in different directions.

Ends of the pattern parts 1142 are connected to the fixing parts 1143. The fixing parts 1143 are fixed to the cover part 1150. Therefore, escaping of the pattern parts 1142 can be prevented. In addition, the fixed ends of the pattern parts 1142 may be used as reference points for designing the resilience of the intermediate member 1140. Owing to the above-described structure of the pattern parts 1142, the center part 1141 may be two-dimensionally moved within a range of about 0.6 mm to about 3.0 mm when a force is applied to the center part 1141. The center part 1141 may be moved in a linear, curved, or circular pattern. When the force is removed from the center part 1141, the center part 1141 may smoothly return to the center position of the fixing parts 1143 by the pattern parts 1142.

When the center part 1141 is moved or rotated by an external force, the pattern parts 1142 support the center part 1141. When the external force is removed (that is, when the center part 1141 is not moved or rotated), the pattern parts 1142 move the center part 1141 to its original position.

The shape of the pattern parts 1142 is not limited to the above-described shapes. That is, the pattern parts 1142 may have various shapes. For example, as the pattern parts 1142, a spiral strip part (for example, having a swirling shape) may be disposed around the center part 1141 between the center part 1141 and the fixing parts 1143. In another example, a plurality of oblique strip parts may be provided as the pattern parts 1142.

In the current embodiment, the fixing parts 1143 are fixed to the cover part 1150. The fixing parts 1143 may be fixed to the cover part 1150 by fitting the fixing parts 1143 into notches of the cover part 1150. In the current embodiment, the fixing parts 1143 are provided in the form of points. However, the present invention is not limited thereto. For example, the fixing parts 1143 may be provided in the form of strips.

As described above, the intermediate member 1140 of the current embodiment includes the fixing protrusion parts 1144. The fixing protrusion parts 1144 extend from the center part 1141 and support the magnet part 1120 for stably transmitting a moving force and a resilient force to the magnet part 1120. The fixing protrusion parts 1144 support portions of the bottom and lateral sides of the magnet part 1120. The fixing protrusion parts 1144 are inserted and fixed between the magnet part 1120 and the actuating member 1130.

Owing to this structure, the magnet part 1120 can be fixed. In addition, the movement of the actuating member 1130 can be transmitted to the pattern parts 1142 through the center part 1141, and the resilient force of the pattern parts 1142 can be transmitted to the actuating member 1130 and the magnet part 1120.

In the current embodiment, the magnet part 1120 is fixed to the actuating member 1130 by the fixing protrusion parts 1144 of the intermediate member 1140, and the actuating member 1130 and the magnet part 1120 are fixed to the cover part 1150 by the fixing parts 1143 of the intermediate member 1140 fixed to the cover part 1150.

The cover part 1150 includes: an accommodation body part including a sidewall part and an upper plate through which a penetration hole is formed; a plurality of fixing notch parts formed in a lower side of the sidewall part; a plurality of fixing hook parts extending from the lower side of the sidewall part; and a plurality of fixing pin parts extending from the lower side of the sidewall part.

When assembled, the post part of the actuating member 1130 protrudes through the penetration hole. The diameter of the penetration hole may be greater than the diameter of the post part. In this case, a gap may be formed between the post part and the penetration hole to allow two-dimensional movement of the magnet part 1120. That is, the magnet part 1120 moves within the circular penetration hole of the cover part 1150.

As described above, the magnet part 1120, the actuating member 1130, the intermediate member 1140, and the cover part 1150 are disposed at the substrate 1110, and the sensor part 1160 is disposed at the bottom side of the substrate 1110 as shown in FIG. 3. The sensor part 1160 outputs sensing signals by detecting magnetic field variations caused by the movement of the magnet part 1120 disposed at the top side of the substrate 1110.

That is, the sensor part 1160 detects movements (two-dimensional movements) of the magnet part 1120 in up, down, left, and right directions. The sensor part 1160 includes a plurality of magnetic sensors configured to output x-axis sensing signals (i.e., ±x-axis coordinate values) according to magnetic field variations caused by a movement of the magnet part 1120 in an x-axis direction, and a plurality of magnetic sensors configured to output y-axis sensing signals (±y-axis coordinate values) according to magnetic field variations caused by a movement of the magnet part 1120 in an y-axis direction.

In addition, a control unit (not shown) amplifies output signals of the magnetic sensors of the sensor part 1160 and detects overall magnetic field variations using the amplified output signals. In the current embodiment, the magnetic sensors of the sensor part 1160 are modulated in one sensor chip. However, the present invention is not limited thereto. That is, instead of modulating the magnetic sensors, the magnetic sensors may be arranged around the magnet part 1120 at four positions (that is, in up, down, left, and right directions), respectively. In this case, the magnetic sensors may be symmetric with respect to the center portion of the magnet part 1120.

In the current embodiment, the magnetic sensors of the sensor part 1160 may be hole devices, semiconductor magnetic resistive devices, or magneto magnetic resistive devices or giant magneto resistive (GMR). The electric characteristics of the magnetic sensors may be varied according to variations of a magnetic field applied to the magnetic sensors. In the current embodiment, the magnetic sensors are hole devices of which output voltages are varied in proportion to the density of a magnetic flux.

In the current embodiment, a sensing signal of the sensor part 1160 includes coordinate data. The pointer is two-dimensionally moved according to the sensing signal. In the following description of the current embodiment, an explanation will be given mainly on a method of controlling the velocity of a pointer according to a sensing signal.

The above-described pointing control unit 1100 outputs a sensing signal in response to a manipulation of a user. Then, the electronic device of the current embodiment recognizes the manipulation of the user and moves the pointer on the screen. In detail, in response to manipulation actions of a user, the pointing control unit 1100 sequentially outputs sensing signals to the pointer control module 2100 of the main body unit 2000, and based on the sequentially received sensing signals, the pointer control module 2100 determines whether the manipulation action of the user varies rapidly or slowly, or stays at an upper or lower limit. Then, based on the determination result, the pointer control module 2100 adds a weight value to a pointer movement control signal and outputs the weighted pointer movement control signal to the display unit 3000. Then, the pointer 100 is moved on the display unit 3000 according to the weighted pointer movement control signal.

The pointer control module 2100 includes a plurality of weight value tables for applying a weight value according to a manipulation of a user. The weight value tables are made based on a plurality of sensor signal sections defined according to the level of a sensing signal. The pointer control module 2100 outputs a pointer movement control signal after adding a weight value selected according to the sensor signal sections to the pointer movement control signal. In the following description, such an operation of the pointer control module 2100 will be explained in detail while explaining a method of moving the pointer 100.

Levels of sensing signals are limited within a predetermined range. The reason for this is that the movement of the magnet part 1120 is restricted by a region (refer to a gap K in FIG. 3) between the cover part 1150 and the actuating member 1130.

Therefore, in the current embodiment, levels of sensing signals measured according to the movement of the magnet part 1120 are classified into a plurality of sections along reference axes (x-axis and y-axis) of the movement. For this, two sensors may be arranged along the x-axis and the y-axis for detecting the movement of the magnet part 1120 using variations of signals output from the sensors. Referring to FIG. 5, sixteen sensor signal sections are defined along each reference axis of the movement of the magnet part 1120 (that is, sixteen sensor signal sections are defined according to the level of a sensing signal), and sensing signals of the pointing control unit 1100 are classified according to the sixteen sensor signal sections. Here, the amount of movement of the magnet part 1120 from a reference section (0 or 8 section) is proportional to the level of a sensing signal. However, the present invention is not limited thereto. For example, the number of the sensor signal sections may be greater than or smaller than the above-described number.

As shown in FIG. 5(a), each of the +x-axis and the +y-axis is divided into first to seventh sections by defining the reference point (the original position of the magnet part 1120) as zero point. That is, zeroth to seventh sensor signal sections are defined. In addition, each of the −x-axis and the −y-axis is divided into ninth to fifteenth sections by defining the reference point (the original position of the magnet part 1120) as eighth point. That is, eighth to fifteenth sensor signal sections are defined. Therefore, sensing signals may be symmetric with respect to the referent point 0 or 8. In other words, 0th and 8th sensing signals have the minimal level, and 7th and 15th sensing signals have the maximal level. The levels of the 7th and 15th sensing signals are opposite in sign. For example, the 7th sensing signal has the right maximal level, and the 15th sensing signal has the left maximal level.

However, the present invention is not limited thereto. For example, as shown in FIG. 5(b), a section including the center point of the movement range of the magnet part 1120 is defined as zeroth or eighth region. Then, the right half of the movement range is divided into first to seventh regions, and the left half of the movement range is divided into ninth to fifteenth regions. Then, sensing signals at the zeroth to fifteenth regions are referred as 0th to 15th sensing signals, respectively. When 0th to 7th sensing signals and 8th to 15th sensing signals are applied to the pointer control module 2100, the pointer control module 2100 controls the movement of the pointer 100 of the display unit (i.e., the velocity and/or displacement of the pointer 100) by increasing or decreasing the level of a pointer movement control signal. In detail, if 0th to 7th sensing signals are sequentially applied to the pointer control module 2100, the pointer control module 2100 outputs a pointer movement control signal having a sequentially increasing level. Similar, if 8th to 15th sensing signals are sequentially applied to the pointer control module 2100, the pointer control module 2100 outputs a pointer movement control signal having a sequentially increased level. On the other hand, if 7th to 0th sensing signals or 15th to 8th sensing signals are sequentially applied to the pointer control module 2100, the pointer control module 2100 outputs a pointer movement control signal having a sequentially decreasing level. The 7th and 15th sensing signals are output when the magnet part 1120 is maximally moved, and the 0th and 8th sensing signals are output when the magnet part 1120 is not moved (thus, the pointer 100 may be not moved). In the case of the 7th and 15th sensing signals indicating that the magnet part 1120 is maximally moved, the pointer may be moved most largely.

The pointer 100 is moved in proportion to the level of a pointer movement control signal. That is, if the level of a pointer movement control signal increases, the pointer 100 is rapidly moved. On the other hand, if the level of a pointer movement control signal decreases, the pointer 100 is slowly moved. The movement of the pointer 100 may be relatively varied.

In the current embodiment, the pointer control module 2100 generates pointer movement control signals having various levels in response to sensing signals output according to user's manipulation. At this time, weight values are applied to the pointer movement control signals to vary the levels of the pointer movement control signals according to variations of successive sensing signals (that is, according to the state of user's manipulation). That is, although the same sensing signal is output when the magnet part 1120 is moved to the same position by a user, the pointer 100 is differently moved according to the previous manipulation of the user (that is, according to the previous sensing signal). In this case, the pointer 100 can be smoothly moved.

In the current embodiment, the pointer control module 2100 of the main body unit 2000 receives sensing signals from the pointing control unit 1100 at regular intervals (of about 1 msec to 100 msec). For example, the pointer control module 2100 may receive sensing signals at intervals of 20 msec. However, the present invention is not limited thereto. That is, the interval may be increased or decreased according to the sensing sensitivity of the pointing control unit 1100 and the response sensitivity of the pointer control module 2100.

The pointer control module 2100 of the current embodiment includes lookup tables as shown in FIGS. 6 through 9 in which different weight values are stored for sensor signal sections.

Positive weight values of the lookup tables are used when the pointer 100 is moved upward or to the right from a reference point of a two-dimensional plane, and Negative weight values of the lookup tables are used when the pointer 100 is moved downward or to the left from the reference point.

The lookup tables may be stored in the pointer control module 2100 or the memory 2200.

Referring to a reference lookup table of FIG. 6, weight values of 1 to 7 are sequentially allocated to 0th to 7th sensing signals. Thus, if 0th to 7th sensing signals are sequentially applied to the pointer control module 2100, the output level of the pointer control module 2100 increases sequentially from the minimal value to the maximal value, and thus the velocity of the pointer 100 increases sequentially on the screen. Weight values of 0 to −7 are sequentially allocated to 8th to 15th sensing signals. This is opposite to the above sequence of the weight values, and thus the velocity of the pointer 100 increases sequentially in the opposite direction.

Referring to a first variable lookup table of FIG. 7, the same weight value of 0 is allocated to 0th and 1st sensing signals; the same weight value of 1 is allocated to 2nd to 4th sensing signals; the same weight value of 3 is allocated to 5th to 7th sensing signals; the same weight value of 0 is allocated to 8th and 9th sensing signals; the same weight value of −1 is allocated to 10th to −12th sensing signals; and the same weight value of −3 is allocated to 13th to 15th sensing signals. The weight values are grouped into three in one direction, such that although sensing signals are steeply varied due to a rapid initial manipulation action on the magnet part 1120 (i.e., due to a rapid movement of the magnet part 1120 at the center position), the pointer 100 can be prevented from being very rapidly moved.

Referring to a second variable lookup table of FIG. 8, the same weight value of 0 is allocated to 0th to 2nd sensing signals; the same weight value of 1 is allocated to 3d and 4th sensing signals; weight values of 3, 4, and 7 are allocated to 5th, 6th, and 7th sensing signals, respectively; the same weight value of 0 is allocated to 8th to 10th sensing signals; the same weight value of −1 is allocated to 11th and 12th sensing signals; and weight values of −3, −4, and −7 are allocated to 13th, 14th, and 15th sensing signals, respectively. Therefore, when the magnet part 1120 is initially moved by a user, the pointer 100 may not be substantially moved in response to sensing signals having low levels and then may be moved in response to sensing signals have intermediate levels. Thus, the pointer 100 can be gradually (less sensitively) moved on the screen so as to finely control the movement of the pointer 100.

Referring to a third variable lookup table of FIG. 9, the same weight value of 0 is allocated to 0th to 1st sensing signals; the same weight value of 1 is allocated to 3d to 4th sensing signals; weight values of 3, 4, and 7 are allocated to 5th, 6th, and 7th sensing signals, respectively; the same weight value of 0 is allocated to 8th and 9th sensing signals; the same weight value of −1 is allocated to 10th to 12th sensing signals; and weight values of −3, −4, and −7 are allocated to 13th, 14th, and 15th sensing signals, respectively. Therefore, when the magnet part 1120 is being moved by a user, the pointer 100 can be sensitively controlled.

As described above, in the current embodiment, the pointer control module 2100 determines the manipulation state of a user based on variations of sensing signals, and the pointer control module 2100 uses a corresponding lookup table based on the determination result, so as to control the movement of the pointer 100 ((the direction and speed of the movement of the pointer 100).

Hereinafter, with reference to FIGS. 10 to 12, a method for controlling movement of the pointer of the electronic device will be explained based on operations of the pointer control module 2100, in accordance with exemplary embodiments. In the following description, the method will be explained mainly based on the case of moving the pointer in the x-axis direction. However, the method can be applied to other cases where the pointer is moved in other directions. In addition, the following explanation is given based on control operations of the velocity of the pointer.

First, in the current embodiment, a sensing signal output from the sensor part 1160 of the pointing control unit 1100 of the input unit 1000 is transmitted to the pointer control module 2100, and the pointer control module 2100 determines whether the sensing signal has a maximal level (S100). That is, it is determined whether a 7th or 15th sensing signal is received. When the magnet part 1120, that is, the actuating member 1130, is at the most distant position from the center position of a movement range, the sensing signal has a maximal level.

If it is determined that the sensing signal has a maximal level, an acceleration mode is performed (S200). The acceleration mode will be described later in detail.

If it is determined that the sensing signal does not have a maximal level, it is determined by using the (immediately) previous sensing signal whether the magnet part 1120 (that is, the actuating member 1130) is at the center position or a position between the center position and the most distant position. That is, it is determined whether the previous sensing signal is a 0th sensing signal (S110). In the current embodiment, the pointer control module 2100 receives sensing signals at intervals of approximately 20 msec, the time interval between the current sensing signal and the previous sensing signal is approximately 20 msec.

If it is determined that the previous sensing signal is not a 0th sensing signal (or an 8th sensing signal), it is determined that the magnet part 1120 is continuously moved by a user, and then a continuous movement mode is performed (S300). The continuous movement mode will be described later in detail.

If it is determined that the previous sensing signal is a 0th sensing signal, it is determined that the magnet part 1120 is initially moved, and sensor signal sections of the previous sensing signal and the current sensing signal are compared. Based on the comparison, it is determined whether the different between the sensor signal sections of the previous sensing signal and the current sensing signal is greater than 2 (S120).

That is, sensor signal sections described in FIG. 5 are compared so as to determine whether there are two or more sensor signal sections between the sensor signal sections of the previous sensing signal and the current sensing signal. For example, if the previous sensing signal is a 0th sensing signal and the current sensing signal is a 3d sensing signal, the section difference is 3. If the previous sensing signal is a 0th sensing signal and the current sensing signal is a 1st sensing signal, the section difference is 1.

If the section difference is greater than 2, it is determined that the actuating member 1130 is rapidly moved by a user. Then, a weight value corresponding to the current sensing signal is selected from the first variable lookup table, and a pointer movement control signal is generated using the current sensing signal and the selected weight value (S130). Then, the pointer 100 is moved on the display unit 3000 using the pointer movement control signal (S140). At this time, although the actuating member 1130 is very rapidly moved by a user, the maximal weight value that can be used to generate a pointer movement control signal is 3 as shown in the first variable lookup table. Therefore, although the actuating member 1130 (that is, the magnet part 1120) is rapidly moved by a user, the pointer 100 may be slowly moved. That is, when the pointer 100 is initially moved from a fixed position by a user manipulating the pointing control unit 1100, a rapid movement of the pointer 100 can be prevented for smooth movement of the pointer 100.

If the section difference is smaller than 2, it is determined that the actuating member 1130 is slowly moved. Then, a weight value corresponding to the current sensing signal is selected from the second variable lookup table, and a pointer movement control signal is generated using the selected weight value (S150). Next, the pointer 100 is moved on the display unit 3000 using the pointer movement control signal (S160). At this time, since the section difference is smaller than 2, the weight value corresponding to the current sensing signal is 0. That is, the pointer 100 is not moved on the screen of the display unit 3000.

In the above description, although the reference section difference is set to 2, the present invention is not limited thereto. For example, the reference section difference may be 3 or 4. However, if the reference section difference is set to 5 or greater, the pointer 100 may not be finely or sensitively moved.

In addition, since the movement of the pointer 100 is controlled based on whether the magnet part 1120 is rapidly moved from its original position (the center position of the movement range), trembling of the pointer 100 (cursor) can be prevented even when external impacts or unstable input voltages are applied to the electronic device.

The acceleration mode will now be described in detail.

If it is determined that the current sensing signal has a maximal level, the acceleration mode is performed as shown in FIG. 11.

In acceleration mode, first, it is determined whether a maximal-level continuation number (K) is greater than a set number (N) (S210). Alternatively, it may be determined whether the value K is equal to or greater than the value N. If it is determined that the value K is smaller than the value N (K<N), 1 is added to the value K (S220). Next, a weight value corresponding to the current sensing signal is selected from the reference lookup table, and a pointer movement control signal is generated using the selected weight value (S230). That is, since the current sensing signal has a maximal level, the pointer movement control signal is generated using a weight value of 7. Instead of using the reference lookup table, the second or third lookup table may be used. Next, the pointer 100 is moved on the display unit 3000 by using the pointer movement control signal to which a weight value selected from the reference lookup table is added (S240).

Thereafter, it is determined whether a new sensing signal has a maximal level (S250). If it is determined that the new sensing signal does not have a maximal level, the acceleration mode is terminated, and the procedure goes back to initial control mode. On the other hand, if it is determined that the new sensing signal has a maximal level, the value K and the value N are compared again (S210). Alternatively, operation S260 where 1 is added to the value K may be performed before operation S210. When the acceleration mode is terminated, the value K is set to zero.

The value N may be a natural number ranging from 2 to 1000. For example, the value N may be a natural number ranging from 2 to 100. Alternatively, the value N may be a natural number ranging from 2 to 15. In the case where the value N is a natural number selected one of 2 to 15, while three to sixteen sensing signals having a maximal level are successively output, the value K is equal to or greater than the value N (K>N). In the way, if the value K is equal to or greater than value N, 1 is added to value K (S260). Next, a pointer movement control signal is generated by using a weight value amplified by a value corresponding to the value K (S270). At this time, the weight value amplified by a value corresponding to the value K may be greater than it original value by about 10% to about 100%. In addition, each time the weight value is amplified, the amplified weight value may be greater than the previous value by about 5% to about 10%. The original weight value for the current sensing signal is 7 as shown in the reference lookup table. In this condition, for example, if the value k increases from 3 to 12, the amplified weight value is 7.7 when the value K is 3, 8.4 when the value K is 4, . . . , 14 when the value K is 12. Alternatively, the amplified weight value may be greater than the original weight value by more than 100%, and each time the weight value is amplified, the amplified weight value may be greater than the previous value by more than about 10%.

Thereafter, the pointer 100 is moved on the display unit 3000 using the pointer movement control signal generated using the amplified weight value (S280). Then, it is determined whether a new sensing signal has a maximal level (S290). If the new sensing signal does not have a maximal level, the acceleration mode is terminated. On the other hand, if it is determined that the new sensing signal has a maximal level, 1 is added to the value K, and a pointer movement control signal is generated using a weight value amplified according to the increased value K, so as to move the pointer 100 on the screen using the pointer movement control signal. In this way, the velocity of the pointer 100 can be increased in proportion to the time during which sensing signals have a maximal level. Therefore, the pointer 100 can be rapidly moved on the screen by a user.

Hereinafter, the continuous movement mode will be explained in detail.

If the current sensing signal does not have a maximal level and the previous sensing signal is not a 0th sensing signal, the continuous movement mode is performed as shown in FIG. 12.

First, it is determined whether the sensing signals are increased or decreased (S310). That is, it is determined whether the magnet part 1120 is moved in a direction from the center position to the most distant position (that is, in the increasing order from a 0th sensing signal to a 7th sensing signal) or in a direction from the most distant position to the center position (that is, in the decreasing order from a 7th sensing signal to a 0th sensing signal). If it is determined that the sensing signals are increased, a pointer movement control signal is generated by selecting a weight value corresponding to the current sensing signal from the third variable lookup table (S320). Next, the pointer 100 is moved on the display unit 3000 using the pointer movement control signal (S330). Then, the continuous movement mode is terminated. In this way, a weight value is selected from the third variable lookup table, and a pointer movement control signal is generated using the selected weight value for controlling the velocity of the pointer 100 on the screen. Therefore, while a user moves the pointer 100 on the screen, the pointer 100 can be rapidly responded.

On the other hand, if it is determined that the sensing signals are decreased, it is determined whether the section difference between the current sensing signal and the previous sensing signal is greater than 2. If the section difference is not greater than 2, a weight value corresponding to the current sensing signal is selected from the third variable lookup table to generate a pointer movement control signal as described above. In operation S340, instead of using 2 as a reference value, 3 or 4 may be used. If it is determined that the section difference is greater than 2 (for example, if the magnet part 1120 is moved from the seventh section to the fourth section), it is determined that the magnet part 1120 is not moved by a user, and then a weight value of 0 is used to generates a pointer movement control signal. That is, the level (output current or voltage) of the pointer movement control signal becomes zero. Then, the movement of the pointer 100 on the screen is stopped (S360).

As described above, in the current embodiment, sensing signals input to the pointer control module are classified into a plurality of sections according to the voltage or current levels of the sensing signals, and different weight values are applied to the classified sensing signals according to the state of user's manipulation for generating pointer movement control signals. Therefore, the pointer can be smoothly and naturally moved on the screen by using the pointer movement control signals.

In the above-described embodiments, an electronic device including an input unit, a main body unit, and a display unit has been described. In other embodiments, some parts of the input unit and some parts of the main body unit may be combined to constitute a pointer device for controlling a pointer on a screen. That is, some parts of the input unit and some parts of the main body unit may be provided in the form of an integrated module.

Furthermore, in the above-described embodiment, the pointer control module may be provided in the form of a program included in a control chip (integrated chip) of the main body unit or stored in a recording medium. Of course, the pointer control module can be provided in the form of a program recorded in the pointing control unit. In the above-described embodiments, movement may include rotation.

The present invention is not limited to the above-described embodiments. Various changes in form and details may be made in the above-described embodiments. In the following description, a method of activating an icon on a screen by using a pointer will be described in accordance with an exemplary embodiment with reference to the accompanying drawings. In the embodiment, according to a program included an electronic device, the pointer may be a mouse pointer, a cursor, or an activated icon.

In the following description, the same explanation as that of the above-described embodiment will be omitted. The technology of the current embodiment may be applied to the above-described embodiment, and vice versa.

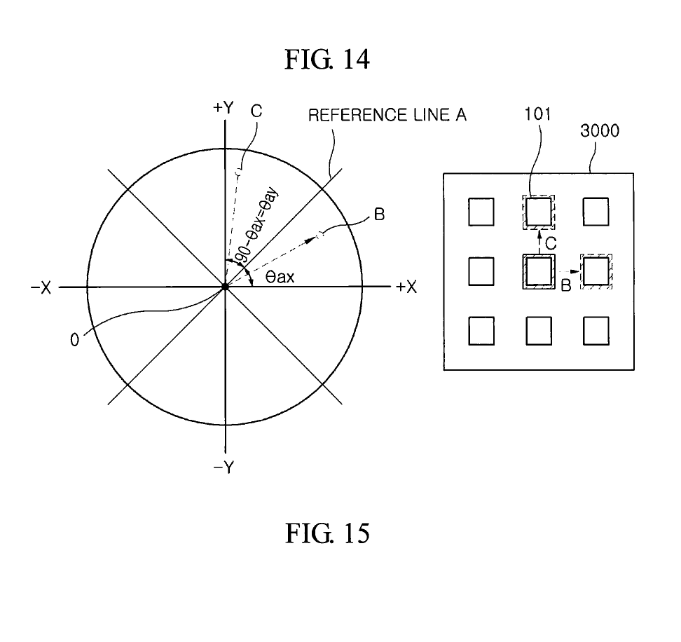

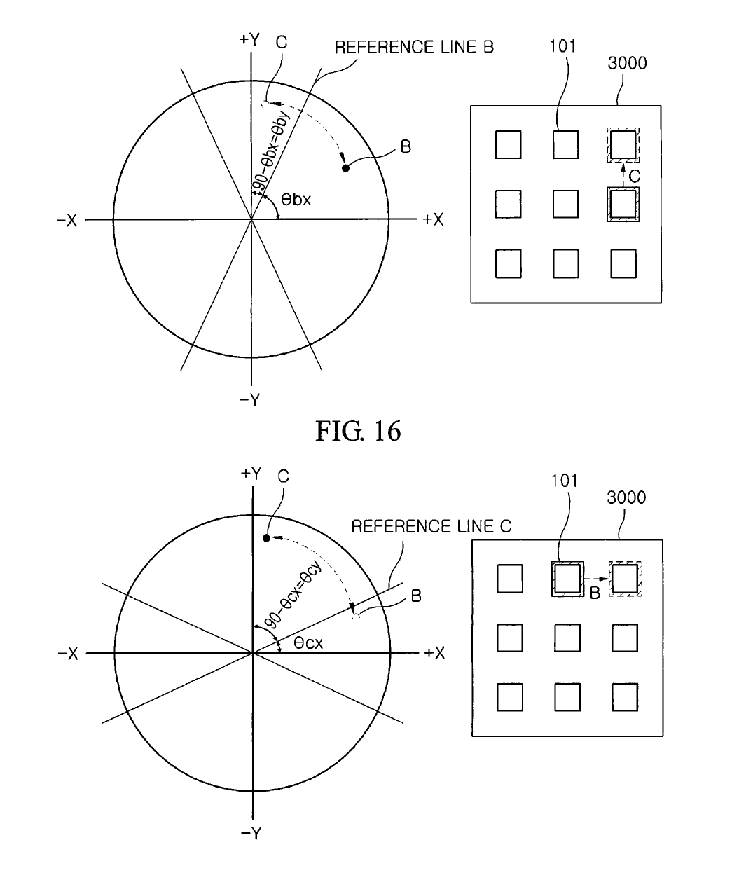

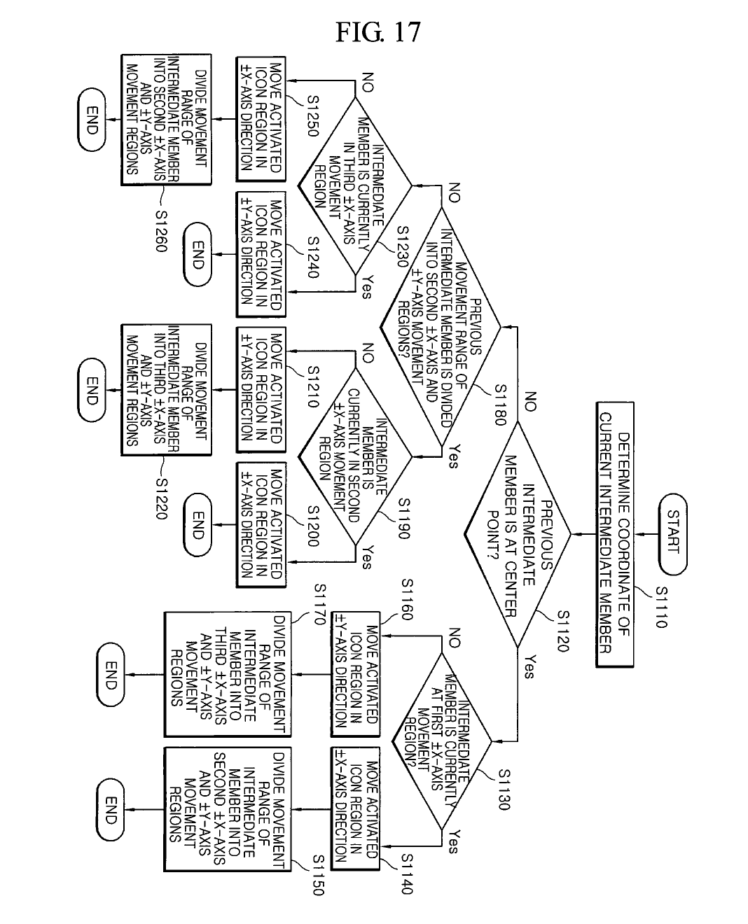

FIG. 13 is a front view illustrating an electronic device in accordance with another exemplary embodiment. FIGS. 14 through 16 are schematic views for explaining operations of the electronic device of FIG. 13. FIG. 17 is a flowchart for explaining a method of activating an icon of an electronic device in accordance with an exemplary embodiment.

Referring to FIGS. 13 through 16, the electronic device of the current embodiment includes: a display unit 3000 configured to display icons 101 and images; an input unit 1000 configured to generate a sensing signal according to user's manipulation for activating the icons 101, and other input signals; and a main body unit 2000 configured to activate the icons 101 according to the sensing signal and transmit a display signal to the display unit 3000 in response to an input signal.

As shown in FIG. 13, the electronic device further includes: a case 40000 configured to accommodate the input unit 1000, the main body unit 2000, and the display unit 3000; and a power supply unit (not shown) configured to supply power to the units.

The input unit 1000 includes a pointing control unit 1100 and a key/button control unit 1200. The pointing control unit 1100 includes a substrate 1110, a magnet part 1120, an actuating member 1130, an intermediate member 1140, a sensor part 1160, and a cover part 1150. The main body unit 2000 includes a pointer control module 2100, a memory 2200, a driving control module 2300, an audio/video control module 2400, and a wire/wireless communication control module 2500.

The input unit 1000, the display unit 3000, and the main body unit 2000 have substantially the same structures as those illustrated in the above embodiments. Thus, descriptions thereof will be omitted.

Based on operations of the pointing control unit 1100 and the pointer control module 2100, an explanation will now be given on a method for controlling movement of an activated region between the icons 101 displayed on a screen of the electronic device.

The actuating member 1130, the magnet part 1120, and the intermediate member 1140 are configured to be moved on a two-dimensional plane in response to user's manipulation.

Thus, a movement range of the actuating member 1130, the magnet part 1120, and the intermediate member 1140 is divided into a plurality of regions. Directions are allocated to the regions, respectively, so as to move an activated icon region according to the allocated directions. For example, in the case where the movement range is divided into five regions, one of the five regions is allocated as a stationary region for not moving the activated icon region; another of the five regions is allocated as a left region for moving the activated icon region to the left; another of the five regions is allocated as a right region for moving the activated icon region to the right; another of the five regions is allocated as an upper region for moving the activated icon region upward; and the other of the five regions is allocated as a lower region for moving the activated icon region downward. However, the present invention is not limited thereto. The movement range can be divided into a plurality of regions in various manners.

The following explanation is given based on the intermediate member 1140. The intermediate member 1140, the magnet part 1120, and the actuating member 1130 are configured to move together. In the following explanation, the term “movement” of the intermediate member 1140 means the movement of the center point of the intermediate member 1140, that is, the movement of a center part 1141 of the intermediate member 1140. Specifically, it means the movement of a center point of the center part 1141 of the intermediate member 1140. In addition, the displacement range of the intermediate member 1140 means the displacement range of the center point of the center part 1141.

As described above, the movement range of the intermediate member 1140 may be divided into a plurality of division regions, and the division regions may be stored as a reference movement range. At this time, a plurality of reference movement ranges can be defined by varying the sizes of the division regions. For example, a first reference movement range may be defined in a manner such that a region for moving an activated icon region to the left is larger than other regions; a second reference movement range may be defined in a manner such that a region for moving an activated icon region to the right is larger than other regions; a third reference movement range may be defined in a manner such that a region for moving an activated icon region upward is larger than other regions; and a fourth reference movement range may be defined in a manner such that a region for moving an activated icon region downward is larger than other regions.

The pointer control module 2100 stores the reference movement ranges and selects one of the stored reference movement ranges according to the position of the intermediate member 1140, so as to move an activated icon region using the selected reference movement range. At this time, one of the stored reference movement ranges is selected in a manner such that the current position of the intermediate member 1140 is located in the largest region of the selected reference movement range. For example, if the intermediate member 1140 is positioned at a left division region (that is, a division region for moving an activated icon region to the left), the first reference movement range is selected. If the intermediate member 1140 is positioned at a lower division region, the fourth reference movement range is selected. In the case where the intermediate member 1140 is placed at the center position of the movement range, a reference movement range of which division regions have the same size may be used. If the intermediate member 1140 is at a boundary between division regions of a reference movement range, it is determined that the intermediate member 1140 is at a left or right division region of the reference movement range. In this way, the whole movement range of the intermediate member 1140 can be used.

In more detail, the intermediate member 1140 of the current embodiment is configured to be moved within a circular two-dimensional plane having x and y axes that crosses each other at a center point. Therefore, the two-dimensional plane is divided into regions based on the x and y axes so as to define axial movement regions, and the axial movement regions are stored. The sizes of the axial movement regions are varied according to the position of the magnet part 1120 and the intermediate member 1140 so as to increase users' manipulation feeling. That is, one of the axial movement regions where the intermediate member 1140 is located is enlarged.

For example, as shown in FIGS. 14 to 16, the magnet part is configured to be moved within a circuit two-dimensional plane having a center point (0) and x and y axes. If the magnet part is moved in the x-axis direction (+x-axis or −x-axis direction), an activated icon region is horizontally moved on the screen as shown in FIG. 13. If the magnet part is moved in the y-axis direction (+y-axis or −y-axis direction), the activated icon region is vertically moved on the screen as shown in FIG. 13. However, the magnet part 1120 (that is, the actuating member 1130) can be moved in a direction between the axes.

In the following description, explanation will be given based on the intermediate member 1140 configured to move the magnet part 1120 and the actuating member 1130 in response to a manipulating force of a user.

In the current embodiment, if the intermediate member 1140 is moved within a predetermined angular range (for example, about ±45 degrees) from one of the x-axis or the y-axis, it is determined that the intermediate member 1140 is moved in the direction of the axis. Furthermore, in the current embodiment, the angular range is varied according to the position of the intermediate member 1140 so as to use the whole movement range of the intermediate member 1140. Therefore, a user can easily move an activated icon region.

In the current embodiment, the pointer control module 2100 of the main body unit 2000 receives a plurality of sensing signals from the pointing control unit 1100 at regular intervals (of about 5 msec to about 100 msec). For example, the regular interval may be 20 msec. However, the regular interval is not limited to the above-described mentioned range. The regular interval may be increased or decreased according to the sensing sensitivity of a sensor and the response sensitivity of the pointer control module 2100.

In the current embodiment, the movement range of the intermediate member 1140 is divided into first to third axial movement regions. That is, the axial movement regions are defined by dividing the movement range of the intermediate member 1140, and if the intermediate member 1140 is moved within one of the axial movement regions, it is determined that that intermediate member 1140 is moved in the direction of an axis corresponding to the axial movement region. The axial movement regions include an x-axis movement region (that is, +x-axis and −x-axis movement regions) and a y-axis movement region (that is, +y-axis and −y-axis movement regions). For example, if the intermediate member 1140 is moved in the +x-axis movement region, it is determined that the intermediate member 1140 is moved in the +x-axis direction.

First ±x-axis and ±y-axis movement regions will now be explained. The first ±x-axis movement region includes a first +x-axis movement region and a first −x-axis movement region. The first ±y-axis movement region includes a +y-axis movement region and a −y-axis movement region. In the following description, the first ±x-axis movement region and the first ±y-axis movement region may also be referred to as a first x-axis movement region and a first y-axis movement region, respectively. Further, a second ±x-axis movement region and a second ±y-axis movement region may also be referred to as a second x-axis movement region and a second y-axis movement region, respectively; and a third ±x-axis movement region and a third ±y-axis movement region may also be referred to as a third x-axis movement region and a third y-axis movement region, respectively.

As shown in FIG. 14, in the x-y two-dimensional plane, the first ±x-axis movement region is an angle 1X (±θax) region defined with respect to the ±x-axis, and the first ±y-axis movement region is the remaining region. That is, the first ±y-axis movement region is an angle 1Y (±θay) region defined with reference to the ±y-axis. Since the x-axis and the y-axis are orthogonal, the sum of θax and θay is 90 degrees.

The angle 1X (±θax) may be ±45 degrees. If necessary, the angle 1X may be varied by a range of about ±10 degrees because the movement region of the intermediate member 1140 can be varied according to the movement behavior of the intermediate member 1140. The angle 1Y (±θay) may be ±45 degrees. In the current embodiment, if the intermediate member 1140 is moved on a ±45 degree line (refer to reference lines A of FIG. 14), it is determined that that the intermediate member 1140 is moved in the first ±x-axis movement region. Therefore, if the intermediate member 1140 is moved between a −45-degree line and a +45-degree line from the x-axis, it is determined that that the intermediate member 1140 is moved within the first ±x-axis movement region (that is, it is determined that the intermediate member 1140 is moved in the +x-axis or −x-axis direction). If the intermediate member 1140 is moved within a region between, but not including, a −45-degree line and a +45-degree line from the ±y-axis, it is determined that that the intermediate member 1140 is moved within the first ±y-axis movement region (that is, it is determined that the intermediate member 1140 is moved in the +y-axis or −y-axis direction). Therefore, axial movement can be defined all over the movement range of the intermediate member 1140. Alternatively, in the case where the intermediate member 1140 is moved on the reference line A, it may be determined that the intermediate member 1140 is moved in the y-axis direction.

If the +x-axis is 0 degrees, the first +x-axis movement region is defined by an angular region equal to or greater than 315 degrees but equal to or smaller than 45 degrees; the first +y-axis movement region is defined by an angular region greater than 45 degrees but smaller than 135 degrees; the first −x-axis movement region is defined by an angular region equal to or greater than 135 degrees but equal to or smaller than 225 degrees; and the first −y-axis movement region is defined by an angular region greater than 225 degrees but smaller than 315 degrees.

The first x-axis and y-axis movement regions may be used when the intermediate member 1140 is initially moved from the center point (0).

Next, the second x-axis and y-axis movement regions will now be explained.

As shown in FIG. 15, the second x-axis movement region is an angle 2X (±θbx) region defined with respect to the x-axis, and the second y-axis movement region is an angle 2Y (±θby) region defined with reference to the y-axis. Since the x-axis and the y-axis are orthogonal, the sum of θbx and θby is 90 degrees.

The angle 2X (±θbx) may be ±60 degrees. If necessary, the angle 2X may be varied by a range of about ±10 degrees because the movement region of the intermediate member 1140 can be varied according to the movement behavior of the intermediate member 1140. The angle 2Y (±θby) may be ±30 degrees. In the current embodiment, if the intermediate member 1140 is moved on a ±60 degree line (refer to reference lines B of FIG. 16), it is determined that that the intermediate member 1140 is moved in the second x-axis movement region. Therefore, if the intermediate member 1140 is moved between a −60-degree line and a +60-degree line from the x-axis, it is determined that that the intermediate member 1140 is moved within the second x-axis movement region (that is, it is determined that the intermediate member 1140 is moved to the left or right). If the intermediate member 1140 is moved within a region between, but not including, a −30-degree line and a +30-degree line from the y-axis, it is determined that that the intermediate member 1140 is moved within the second y-axis movement region (that is, it is determined that the intermediate member 1140 is moved upward or downward). Therefore, axial movement can be defined all over the movement range of the intermediate member 1140.

In detail, if the +x-axis is 0 degrees, the second +x-axis movement region is defined by an angular region equal to or greater than 300 degrees but equal to or smaller than 60 degrees; the second +y-axis movement region is defined by an angular region greater than 60 degrees but smaller than 120 degrees; the second −x-axis movement region is defined by an angular region equal to or greater than 120 degrees but equal to or smaller than 240 degrees; and the second −y-axis movement region is defined by an angular region greater than 240 degrees but smaller than 300 degrees.

The second x-axis and y-axis movement regions may be used after it is determined that the intermediate member 1140 is moved from the center point (0) in the x-axis direction, or after the intermediate member 1140 is moved from the y-axis movement region to the x-axis movement region.

Next, the third x-axis and y-axis movement regions will now be explained. As shown in FIG. 16, the third x-axis movement region is an angle 3X (±θcx) region defined with respect to the x-axis, and the third y-axis movement region is an angle 3Y (±θcy) region defined with reference to the y-axis. Since the x-axis and the y-axis are orthogonal, the sum of θcx and θcy is 90 degrees.

The angle 3X (±θcx) may be ±30 degrees. If necessary, the angle 3X may be varied by a range of about ±10 degrees because the movement region of the intermediate member 1140 can be varied according to the movement behavior of the intermediate member 1140. The angle 3Y (±θcy) may be ±60 degrees. In the current embodiment, if the intermediate member 1140 is moved on a ±30 degree line (refer to reference lines C of FIG. 16), it is determined that that the intermediate member 1140 is moved in the third x-axis movement region. Therefore, if the intermediate member 1140 is moved between a −30-degree line and a +30-degree line from the x-axis, it is determined that that the intermediate member 1140 is moved within the third x-axis movement region (that is, it is determined that the intermediate member 1140 is moved to the left or right). If the intermediate member 1140 is moved within a region between, but not including, a −60-degree line and a +60-degree line from the y-axis, it is determined that that the intermediate member 1140 is moved within the third y-axis movement region (that is, it is determined that the intermediate member 1140 is moved upward or downward). Therefore, axial movement can be defined all over the movement range of the intermediate member 1140. However, the present invention is not limited thereto. Alternatively, in the case where the intermediate member 1140 is moved on the reference line C, it may be determined that the intermediate member 1140 is moved in the third y-axis movement region.

If the +x-axis is 0 degrees, the third +x-axis movement region is defined by an angular region equal to or greater than 330 degrees but equal to or smaller than 30 degrees; the third +y-axis movement region is defined by an angular region greater than 30 degrees but smaller than 150 degrees; the third −x-axis movement region is defined by an angular region equal to or greater than 150 degrees but equal to or smaller than 210 degrees; and the third −y-axis movement region is defined by an angular region greater than 210 degrees but smaller than 330 degrees.

The third x-axis and y-axis movement regions may be used after it is determined that the intermediate member 1140 is moved from the center point (0) in the y-axis direction, or after the intermediate member 1140 is moved from the x-axis movement region to the y-axis movement region.

As described above, in the current embodiment, the movement range of the intermediate member 1140 is divided into the first x-axis movement region and the first y-axis movement region. Alternatively, the movement range of the intermediate member 1140 is divided into the second x-axis movement region greater than the first x-axis movement region, and the second y-axis movement region smaller than the first y-axis movement region. Alternatively, the movement range of the intermediate member 1140 is divided into the third x-axis movement region smaller than the first x-axis movement region, and the third y-axis movement region greater than the first y-axis movement region. Therefore, an activated icon region can be moved on the screen by using one pair of the first to third x-axis and y-axis movement regions.

In the following description, with reference to the accompanying drawings, an explanation will be given on a method of varying a region defined for recognizing a movement direction of an activated icon region according to movement of an intermediate member 1140.

If the intermediate member 1140 is at the center point (0), the first x-axis movement region and the first y-axis movement region as shown in FIG. 14 are used to determined a direction in which an activated icon region is to be moved. If the intermediate member 1140 is moved from the center point (0) to the first x-axis movement region, the second x-axis movement region and the second y-axis movement region are re-defined as shown in FIG. 15. If the intermediate member 1140 is moved from the center point (0) to the first y-axis movement region, the third x-axis movement region and the third y-axis movement region are re-defined as shown in FIG. 16.

In addition, if the intermediate member 1140 is moved from the second x-axis movement region to the second y-axis movement region, the third x-axis movement region and the third y-axis movement region are used. If the intermediate member 1140 is moved from the third y-axis movement region to the third x-axis movement region, the second x-axis movement region and the second y-axis movement region are used.

For example, if the intermediate member 1140 is at the center point (0), the movement range of the intermediate member 1140 is divided into the first x-axis movement region and the first y-axis movement region as shown in FIG. 14. Then, if the intermediate member 1140 is moved from the center point (0) to a first point (B) located in the first x-axis movement region, the activated icon region is moved in the +x-axis direction (that is, to the right) such that an icon located at the right side of the initial position of the activated icon region can be activated as shown in FIG. 15. Then, the movement range of the intermediate member 1140 is divided into the second x-axis movement region and the second y-axis movement region.

If the intermediate member 1140 is moved from the center point (0) to a second point (C) located in the first y-axis movement region, the activated icon region is moved in the +y-axis direction (that is, upward) such that an icon located at the upper side of the initial position of the activated icon region can be activated as shown in FIG. 16. Then, the movement range of the intermediate member 1140 is divided into the third x-axis movement region and the third y-axis movement region.

As shown in FIG. 15, if the intermediate member 1140 is moved from the first point (B) to the second point (C) located in the second y-axis movement region, the activated icon region is moved on the screen in the +y-axis direction, and the movement range of the intermediate member 1140 is changed from the second x-axis and y-axis movement regions to the third x-axis and y-axis movement regions.

As shown in FIG. 16, if the intermediate member 1140 is moved from the second point (C) to the first point (B) located in the third x-axis movement region, the activated icon region is moved in the +x-axis direction, and the movement range of the intermediate member 1140 is changed from the third x-axis and y-axis movement regions to the second x-axis and y-axis movement regions.

In this way, after the intermediate member 1140 is initially moved, the axial movement regions of the movement range of the intermediate member 1140 are varied according to the movement direction of the intermediate member 1140, so as to improve manipulation sensitivity for a user and use the whole movement range (movement space) of the intermediate member 1140.

The above-described operations will be explained with reference to the flowchart of FIG. 17. In FIG. 17, the case where the intermediate member 1140 is not moved from the center point (0) is not explained.

As described above, in the current embodiment, the pointer control module 2100 receives a plurality of sensing signals from the pointing control unit 1100 and generates control signals to move an activated icon region on the display unit 3000 in ±x and ±y axis directions (that is, right, left, upward, and downward).

At this time, the pointer control module 2100 receives successive sensing signals for a predetermined time.

Thus, the pointer control module 2100 determines the current position (coordinate) of the intermediate member 1140 using a currently received sensing signal (S1110).

At this time, the position of the intermediate member 1140 is determined by using a current position vector of the intermediate member 1140 based on the center point (0). The two sensors of the pointing control unit 1100 are disposed on the x-axis and the other two sensors are disposed on the y-axis. Therefore, sensing signals of the sensors are varied according to the magnet part 1120 moved by the intermediate member 1140. Thus, the position of the intermediate member 1140 can be detected by the levels of the sensing signals of the sensors.

Next, it is determined whether the position of the intermediate member 1140 is at the center point (0) (S1120).

If it is determined that the previous position of the intermediate member 1140 is at the center point (0), it is determined whether the current position of the intermediate member 1140 is in the first ±x-axis movement region or the first ±y-axis movement region (S1130). If it is determined that the current position of the intermediate member 1140 is in the first ±x-axis movement region, an activated icon region is moved in the ±x-axis direction (that is, the activated icon region is moved in the +x-axis or −x-axis direction according to the movement direction of the intermediate member 1140) (S1140). Next, the movement range of the intermediate member 1140 is changed to the second ±x-axis movement region and the second ±y-axis movement region (S1150). On the other hand, if it is determined that the current position of the intermediate member 1140 is in the first ±y-axis movement region, the activated icon region is moved in the ±y-axis direction (that is, the activated icon region is moved in the +y-axis or −y-axis direction according to the movement direction of the intermediate member 1140) (S1160). Next, the movement range of the intermediate member 1140 is changed to the third ±x-axis movement region and the third ±y-axis movement region (S1170).

If it is determined that the previous position of the intermediate member 1140 is not at the center point (0), it is determined whether the previous movement range of the pointing control unit 1100 is divided into the second ±x-axis and ±y movement regions or the third ±x-axis and ±y-axis movement regions (that is, it is determined whether the previous axial movement regions of the intermediate member 1140 determined by the previous position of the intermediate member 1140 are the second ±x-axis and ±y movement regions or the third ±x-axis and ±y-axis movement regions) (S1180). If it is determined that the previous movement range of the intermediate member 1140 is divided into the second ±x-axis and ±y-axis movement regions, it is determined whether the current position of the intermediate member 1140 is in the second ±x-axis movement region (S1190). If it is determined that the current position of the intermediate member 1140 is in the second ±x-axis movement region, the activated icon region is moved in the ±x-axis direction, and the axial movement regions are fixed (S1200). If it is determined that the current position of the intermediate member 1140 is in the second ±y-axis movement region, the activated icon region is moved in the ±y-axis direction (S1210), and the movement range (axial movement regions) of the intermediate member 1140 is changed to the third ±x-axis and ±y-axis movement regions (S1220). On the other hand, if it is determined that the previous movement range of the intermediate member 1140 is divided into the third ±x-axis and ±y-axis movement regions, it is determined whether the current position of the intermediate member 1140 is in the third ±y-axis movement region (S1230). If it is determined that the current position of the intermediate member 1140 is in the third ±y-axis movement region, the activated icon region is moved in the ±y-axis direction (S1250), the movement range of the intermediate member 1140 is changed to the second ±x-axis and ±y-axis movement regions (S1260).

As described above, according to the current embodiment, an activated icon region can be easily moved on the display unit by the pointer control module according to the movement of the intermediate member configured to be moved within a restricted two-dimensional plane. At this time, the movement range of the intermediate member is divided into a plurality of axial movement regions according to the movement of the intermediate member, so as to selectively use the axial movement regions according to the previous and current positional states (e.g., coordinates) of the intermediate member. Owing to this variable (flexible) use of the axial movement regions, a user can have good manipulation feeling when the user moves an activated icon region on a screen. In addition, the whole movement range of the intermediate member can be used by using the x-axis or the y-axis as a reference line for defining the axial movement regions.

In the above-described embodiments, the electronic device includes the input unit, the main body unit, and the display unit. However, in other embodiments, some parts of the input unit and some parts of the main body unit may be combined to constitute a pointer device for controlling a pointer on a screen. That is, some parts of the input unit and some parts of the main body unit may be provided in the form of an integrated module.

Furthermore, in the above-described embodiments, the pointer control module may be provided in the form of a program included in a control chip (integrated chip) of the main body unit or stored in a recording medium. Of course, the pointer control module can be provided in the form of a program recorded in the pointing control unit.

In addition, in the above-described embodiments, a pointer (a mouse pointer or a cursor) may be positioned on a screen according to a mode selection signal applied to the pointer control module. Then, as explained above, the pointer can be moved on the screen in the x-axis and y-axis directions according to the movement of the magnet part and the intermediate member, so as to activate one of icons displayed on the screen. That is, an icon on which the pointer is placed may be activated. However, the present invention is not limited thereto. For example, an icon may be activated by moving the pointer on the screen in the same direction as the movement direction of the intermediate member.

Although an electronic device and a method for controlling movement of a pointer of the electronic device have been described with reference to the specific embodiments, it is not limited thereto. Therefore, it will be readily understood by those skilled in the art that various modifications and changes can be made thereto without departing from the spirit and scope of the present invention defined by the appended claims.

1. A method for controlling movement of a pointer on a screen of an electronic device by using pointer movement control signals generated using sensing signals, which have various levels and are generated according to user's manipulation of a sensor, the method comprising:
defining a plurality of sections corresponding to the sensing signals and classifying the sensing signals into 0th to Mth sensing signals according to the sections;
generating and storing a reference lookup table and a plurality of variable lookup tables, the reference lookup table storing weight values that correspond to the 0th to Mth sensing signals and levels of the pointer movement control signals, each of the variable lookup tables storing weight values that correspond to the 0th to Mth sensing signals and are different from the weight values of the reference lookup table;
determining whether a current sensing signal has a maximal level;
if the current sensing signal has the maximal level, performing an acceleration mode so as to accelerate the movement of the pointer on the screen, and if the current sensing signal does not have the maximal level, determining whether a previous sensing signal has a minimal level;
if the previous sensing signal does not have the minimal level, performing a continuous movement mode, and if the previous sensing signal has the minimal level, comparing sections of the previous and current sensing signals;
if a difference between the sections of the previous and current sensing signals is greater than L, generating a pointer movement control signal having a weight value corresponding to the current sensing signal by using a first one of the variable lookup tables, and if the difference of the sections is not greater than the L, generating a pointer movement control signal having a weight value corresponding to the current sensing signal by using a second one of the variable lookup tables.

2. The method of claim 1, wherein the performing of the acceleration mode comprises:
determining whether a maximal-level continuation number K is greater than N;
if the K is smaller than the N, generating a pointer movement control signal having a weight value corresponding to the current sensing signal by using the reference lookup table, adding 1 to the K, determining whether the increased K is greater than the N if a next new sensing signal has the maximal level, and terminating the acceleration mode if the new sensing signal does not have the maximal level; and
if the K is equal to or greater than the N, generating a pointer movement control signal having a weight value that is obtained by increasing a weight value of the reference lookup table corresponding to the maximal level by a value corresponding to the K, adding 1 to the K if the next new sensing signal has the maximal level, and generating a pointer movement control signal having a new weight value obtained by increasing the weight value of the reference lookup table corresponding to the maximal level by a value corresponding to the increased K.

3. The method of claim 2, wherein the L is a natural number selected from 2, 3, and 4, and the N is a natural number selected from 2 to 15.

4. The method of claim 1, wherein the performing of the continuous movement mode comprises:
determining whether levels of the sensing signals are increased or decreased;
if the levels of the sensing signals are increased, generating a pointer movement control signal having a weight value corresponding to the current sensing signal by using a third one of the variable lookup tables; and
if the levels of the sensing signals are decreased, comparing the sections of the previous and current sensing signals so as to generate a pointer movement control signal having a zero level if the difference between the sections of the previous and current sensing signals is greater than P and a pointer movement control signal having a weight value corresponding to the current sensing signal by using the third one of the variable lookup tables if the difference between the sections of the previous and current sensing signals is smaller than the P.

5. The method of claim 4, wherein the P is a natural number selected from 2, 3, and 4.

6. The method of claim 1, wherein the sensor is a magnet part, and the levels of the sensing signals are varied according to movement of the magnet part,
wherein a length of an axis defined from an original position of the magnet part to the most distant position of the magnet part from the original position is divided into first to seventh sensor signal sections to classify the levels of the sensing signals into first to seventh levels according to the first to seventh sensor signal sections.

7. The method of claim 6, wherein the reference lookup table and the variable lookup tables comprise:
first weight values corresponding to sections of an x-axis or a y-axis defined in a +x-axis or +y-axis direction from the original position of the magnet part to the most distant position of the magnet part; and
second weight values corresponding to sections of the x-axis or the y-axis defined in a −x-axis or −y-axis direction from the original position of the magnet part to the most distant position of the magnet part,
wherein the first weight values are positive or negative in sign, the second weight values have the opposite sign, and the first weight values and the second weight values are equal in absolute value.

8. The method of claim 6, wherein the weight values of the reference lookup table increase sequentially in accordance with the first to seventh levels of the sensing signals;
the weight values of the first one of the variable lookup tables comprise 0 corresponding to the first level, 1 corresponding to the second to fourth levels, and 3 corresponding to the fifth to seventh levels;
the weight values of the second one of the variable lookup tables comprise 0 corresponding to the first and second levels, 1 corresponding to the third and fourth levels, and 3, 4, and 7 corresponding to the fifth, sixth, and seventh levels, respectively; and
the weight values of the third one of the variable lookup tables comprise 0 corresponding to the first level, 1 corresponding to the second to fourth levels, and 3, 4, and 7 corresponding to the fifth, sixth, and seventh levels, respectively.

9. An electronic device, comprising:
a pointing control unit configured to output sensing signals having various levels by detecting movement of a magnet part in a hole-shaped movement space; and
a pointer control module configured to define a plurality of sections corresponding to the sensing signals, define the sensing signals as 0th to Mth sensing signals according to the sections, use the 0th to Mth sensing signals, and a reference lookup table and a plurality of variable lookup tables storing various weight values corresponding to levels of pointer movement control signals for controlling movement of a pointer on a screen, and generate a pointer movement control signal having a weight value corresponding to a current sensing signal by using the current sensing signal and a previous sensing signal.

10. The electronic device of claim 9, wherein the pointer control module is configured to perform the operations of:
if the current sensing signal has a maximal level, performing an acceleration mode so as to accelerate the movement of the pointer on the screen,
if the current sensing signal does not have the maximal level, determining whether the previous sensing signal has a minimal level to perform a continuous movement mode if the previous sensing signal does not have the minimal level, and
if the previous sensing signal has the minimal level, comparing sections of the previous and current sensing signals to generate a pointer movement control signal having a weight value corresponding to the current sensing signal by using one of the variable lookup tables if a difference between the sections of the previous and current sensing signals is greater than L, and generate a pointer movement control signal having a weight value corresponding to the current sensing signal by using another of the variable lookup tables if the difference of the sections is not greater than the L.

11-13. (canceled)

14. A method for controlling movement of a pointer of an electronic device to activate an icon of the electronic device by moving an activated icon region on a screen according to movement of an intermediate member confined in a movement range of a two-dimensional plane, the method comprising:
dividing the movement range of the intermediate member into a plurality of division regions to which movement directions of the activated icon region are allocated, and storing a plurality of reference movement ranges by varying sizes of the division regions of the movement range so that the division regions of each of the reference movement ranges have different sizes from the division regions of the other reference movement ranges; and
selecting one of the reference movement ranges according to a position of the intermediate member so as to move the activated icon region on the screen by using the selected reference movement range.

15. The method of claim 14, wherein the selecting of one of the reference movement ranges is performed by selecting one of the reference movement ranges having a largest division region where the position of the intermediate member is located,
wherein the intermediate member is two-dimensionally moved with respect to a center point of the movement range, and the movement range is divided into the plurality of division regions based on the center point,
wherein when the intermediate member is placed at the center point of the movement range, one of the reference movement ranges of which division regions have the same size is selected.

16. The method of claim 15, wherein the division regions comprise an upper division region at an upper side of the center point, a lower division region at a lower side of the center point, a left division region at a left side of the center point, and a right division region at a right side of the center point, and
when the intermediate member is placed on a boundary of the division regions, it is determined that the intermediate member is placed on the left or right division region.

17. The method of claim 16, wherein if the intermediate member is placed at the center point, the upper, lower, left, and right division regions become 90-degree angular regions defined with respect to the center point, and
if the intermediate member is moved from the center point to one of the upper, lower, left, and right division regions, the corresponding division region is enlarged to an approximately 100-degree to 140-degree angular region with respect to the center point, and two of the remaining division regions adjacent to the enlarged division region are reduced in size by the enlarged size of the enlarged division region.

18. A method for controlling movement of a pointer of an electronic device to activate an icon of the electronic device by moving an activated icon region on a screen according to movement of an intermediate member confined in a movement range of a two-dimensional plane defined by an x-axis and a y-axis, the method comprising:
dividing the movement range of the intermediate member into ±x-axis movement regions adapted to move the activated icon region in an x-axis direction, and ±y-axis movement regions adapted to move the activated icon region in a y-axis direction; and
enlarging one pair of the ±x movement regions and the ±y-axis movement regions where the intermediate member is placed as compared with the other pair of the ±x movement regions and the ±y-axis movement regions where the intermediate member is not placed.

19. The method of claim 18, wherein if the intermediate member is placed at a center point of the movement range, the ±x-axis movement regions and the ±y-axis movement regions have the same size, and
if the intermediate member is placed on a boundary between the ±x movement regions and the ±y-axis movement regions, the ±x-axis movement regions are enlarged relative to the ±y-axis movement regions.

20. The method of claim 19, further comprising:
storing a first movement range by dividing the movement range of the intermediate member into ±x-axis movement regions and ±y-axis movement regions having the same size, a second movement range by dividing the movement range of the intermediate member into ±x-axis movement regions and ±y-axis movement regions smaller than the ±x-axis movement regions, a third movement range by dividing the movement range of the intermediate member into ±x-axis movement regions and ±y-axis movement regions larger than the ±x-axis movement regions;
if the intermediate member is placed at the center point of the movement range, determining a movement direction of the activated icon region by using the first movement range;
if the intermediate member is placed in the +x-axis or −x-axis movement region, determining the movement direction of the activated icon region by using the second movement range; and
if the intermediate member is placed in the +y-axis or −y-axis movement region, determining the movement direction of the activated icon region by using the third movement range.

21. The method of claim 19, further comprising:
storing a first movement range by dividing the movement range of the intermediate member into ±x-axis movement regions and ±y-axis movement regions having the same size, a second movement range by dividing the movement range of the intermediate member into ±x-axis movement regions and ±y-axis movement regions smaller than the ±x-axis movement regions, a third movement range by dividing the movement range of the intermediate member into ±x-axis movement regions and ±y-axis movement regions larger than the ±x-axis movement regions;
if a previous position of the intermediate member is the center point of the movement range, determining a movement direction of the activated icon region according to a current position of the intermediate member by using the first movement range;
if the current position of the intermediate member is in the +x-axis or −x-axis movement region, using the second movement range instead of the first movement range; and
if the current position of the intermediate member is in the +y-axis or −y-axis movement region, using the third movement range instead of the first movement range.

22. The method of claim 18, wherein the ±x-axis movement regions of the first movement range are angular regions equal to or greater than −45 degrees but equal to or smaller than +45 degrees with respect to the x-axis, and the ±y-axis movement regions of the first movement range are angular regions greater than −45 degrees but smaller than +45 degrees with respect to the y-axis,
the ±x-axis movement regions of the second movement range are angular regions equal to or greater than −60 degrees but equal to or smaller than +60 degrees with respect to the x-axis, and the ±y-axis movement regions of the second movement range are angular regions greater than −30 degrees but smaller than +30 degrees with respect to the y-axis, and
the ±x-axis movement regions of the third movement range are angular regions equal to or greater than −30 degrees but equal to or smaller than +30 degrees with respect to the x-axis, and the ±y-axis movement regions of the third movement range are angular regions greater than −60 degrees but smaller than +60 degrees with respect to the y-axis.

23. The method of claim 22, wherein if the +x-axis is 0 degrees, the +x-axis movement region of the first movement range is defined by an angular region equal to or greater than 315 degrees but equal to or smaller than 45 degrees, the +y-axis movement region of the first movement range is defined by an angular region greater than 45 degrees but smaller than 135 degrees; the −x-axis movement region of the first movement range is defined by an angular region equal to or greater than 135 degrees but equal to or smaller than 225 degrees; and the −y-axis movement region of the first movement range is defined by an angular region greater than 225 degrees but smaller than 315 degrees;
if the +x-axis is 0 degrees, the +x-axis movement region of the second movement range is defined by an angular region equal to or greater than 300 degrees but equal to or smaller than 60 degrees; the +y-axis movement region of the second movement range is defined by an angular region greater than 60 degrees but smaller than 120 degrees; the −x-axis movement region of the second movement range is defined by an angular region equal to or greater than 120 degrees but equal to or smaller than 240 degrees; and the −y-axis movement region of the second movement range is defined by an angular region greater than 240 degrees but smaller than 300 degrees; and
if the +x-axis is 0 degrees, the +x-axis movement region of the third movement range is defined by an angular region equal to or greater than 330 degrees but equal to or smaller than 30 degrees; the +y-axis movement region of the third movement range is defined by an angular region greater than 30 degrees but smaller than 150 degrees; the −x-axis movement region of the third movement range is defined by an angular region equal to or greater than 150 degrees but equal to or smaller than 210 degrees; and the −y-axis movement region of the third movement range is defined by an angular region greater than 210 degrees but smaller than 330 degrees.

24-29. (canceled)
